(19) United States
(12) Patent Application Publication
(10) Pub. No.: US 2015/0192083 A1
(43) Pub. Date: Jul. 9, 2015

(54) INTER-CYLINDER AIR-FUEL RATIO VARIATION ABNORMALITY DETECTION APPARATUS

(71) Applicant: Toyota Jidosha Kabushiki Kaisha, Toyota-shi (JP)

(72) Inventors: Kenji Suzuki, Susono-shi (JP); Yasushi Iwazaki, Ebina-shi (JP); Hiroshi Miyamoto, Sunto-gun (JP)

(21) Appl. No.: 14/556,808

(22) Filed: Dec. 1, 2014

(30) Foreign Application Priority Data
Jan. 8, 2014 (JP) 2014-001909

(51) Int. Cl. F02D 41/14; G01M 15/10; F02D 41/00

(52) U.S. Cl. CPC F02D 41/1454; F02D 41/0085; G01M 15/10

(57) ABSTRACT

An apparatus according to the present invention includes a control apparatus to detect an inter-cylinder air-fuel ratio variation abnormality based on an output fluctuation parameter correlated with a degree of variation in output from an air-fuel ratio sensor. The control apparatus is configured to calculate a positive slope value and a negative slope value when the output from the air-fuel ratio sensor changes to lean side and to a rich side; calculate a determination index value by dividing a difference or a ratio between the positive slope value and the negative slope value by an amplitude index value correlated with a magnitude of a maximum amplitude of the output waveform from the air-fuel ratio sensor; and determine whether a deviation of the air-fuel ratio in one cylinder is a lean-side deviation or a rich-side deviation, based on the determination index value.

### CROSS REFERENCES TO RELATED APPLICATIONS

This application claims the benefit of Japanese Patent Application No. 2014-001909, filed Jan. 8, 2014, which is hereby incorporated by reference herein in its entirety.

### BACKGROUND OF THE INVENTION

1. Field of the Invention

The present invention relates to an inter-cylinder air-fuel ratio variation abnormality detection apparatus for a multicylinder internal combustion engine, and in particular, to an apparatus that detects abnormality (imbalance abnormality) in which some cylinders have an air-fuel ratio relatively significantly deviating from the air-fuel ratio of the remaining cylinders.

2. Description of the Related Art

In general, to efficiently remove harmful exhaust components for purification using a catalyst, an internal combustion engine with an exhaust purification system utilizing the catalyst needs to control the mixing ratio between air and fuel in an air-fuel mixture combusted in the internal combustion engine, that is, the air-fuel ratio. For such control of the air-fuel ratio, an air-fuel ratio sensor is provided in an exhaust passage in the internal combustion engine to perform feedback control to make the detected air-fuel ratio equal to a predetermined air-fuel ratio.

On the other hand, a multicylinder internal combustion engine normally controls the air-fuel ratio using identical controlled variables for all cylinders. Thus, even when the air-fuel ratio control is performed, the actual air-fuel ratio may vary among the cylinders. In this case, if the variation is at a low level, the variation can be absorbed by the air-fuel ratio feedback control, and the catalyst also serves to remove harmful exhaust components for purification. Consequently, such a low-level variation is prevented from affecting exhaust emissions and from posing an obvious problem.

However, if, for example, fuel injection systems for any cylinders become defective to significantly vary the air-fuel ratio among the cylinders, the exhaust emissions disadvantageously deteriorate. Such a significant variation in air-fuel ratio as deteriorates the exhaust emissions is desirably detected as abnormality. In particular, for automotive internal combustion engines, there has been a demand to detect variation abnormality in air-fuel ratio among the cylinders in a vehicle mounted state (on board) in order to prevent a vehicle with deteriorated exhaust emissions from travelling.

For detection of an inter-cylinder air-fuel ratio variation abnormality, a parameter correlated with the degree of a variation in the output from the air-fuel sensor may be calculated so that variation abnormality can be detected based on the calculated parameter.

Furthermore, if the air-fuel ratio varies, a possible cause is that the air-fuel ratios in some of the cylinders deviate toward a lean side or a rich side. Thus, enabling distinguishable determination of whether a lean- or rich-side deviation is occurring is desirable.

In this regard, Japanese Patent No. 5115657 discloses that whether a lean- or a rich-side deviation is occurring is determined by acquiring the positive and negative slopes of an output waveform from the air-fuel ratio sensor and comparing the positive and negative slopes in magnitude.

However, the results of studies conducted by the inventors indicate that whether a lean- or a rich-side deviation is occurring is not always able to be accurately determined simply by comparing the positive and negative slopes in magnitude.

Thus, the present invention has been developed in view of the above-described circumstances. An object of the present invention is to provide an inter-cylinder air-fuel ratio variation abnormality detection apparatus that enable accurate determination of whether the deviation is a lean-side deviation or a rich-side deviation.

### SUMMARY OF THE INVENTION

An aspect of the present invention provides an inter-cylinder air-fuel ratio variation abnormality detection apparatus including:

an air-fuel ratio sensor installed in an exhaust passage common to a plurality of cylinders in a multicylinder internal combustion engine; and a control apparatus configured to calculate an output fluctuation parameter correlated with a degree of variation in output from the air-fuel ratio sensor and to detect an inter-cylinder air-fuel ratio variation abnormality based on the calculated output fluctuation parameter, in which the control apparatus is configured to execute:

(a) a step of calculating, for an output waveform from the air-fuel ratio sensor during at least one cycle of the internal combustion engine, a positive slope value indicative of a magnitude of a slope of the output from the air-fuel ratio sensor obtained when the output from the air-fuel ratio sensor changes to a lean side and a negative slope value indicative of the magnitude of the slope obtained when the output from the air-fuel ratio sensor changes to a rich side;

(b) a step of calculating a determination index value by dividing a difference or a ratio between the positive slope value and the negative slope value by an amplitude index value correlated with a magnitude of a maximum amplitude of the output waveform from the air-fuel ratio sensor; and

(c) a step of determining whether a deviation of the air-fuel ratio in one cylinder with a most significant deviation of the air-fuel ratio is a lean-side deviation or a rich-side deviation, based on the determination index value.

Preferably, the amplitude index value is a sum of the positive slope value and the negative slope value.

Preferably, in the step (c), the control apparatus compares the determination index value with a predetermined threshold to determine whether the deviation of the air-fuel ratio is a lean-side deviation or a rich-side deviation.

Preferably, in the step (b), the control apparatus calculates the determination index value by subtracting the negative slope value from the positive slope value and dividing a resultant difference by the amplitude index value, and the threshold is a negative value.

Preferably, in the step (C), the control apparatus corrects the determination index value or the threshold depending on an operating status of the internal combustion engine.

Preferably, the control apparatus is configured to execute, before the step (a),

(d) a step of identifying a total of two cylinders including one cylinder estimated to have a lean-side deviation of the air-fuel ratio and one cylinder estimated to have a rich-side deviation of the air-fuel ratio based on the output waveform from the air-fuel ratio sensor during at least one cycle of the internal combustion engine, and after the step (c),

(e) a step of identifying one of the two cylinders identified in the step (d) that has the most significant deviation of the air-fuel ratio.

Preferably, in the step (d), the control apparatus identifies the two cylinders based on a lean-side peak phase and a rich-side peak phase of the output waveform from the air-fuel ratio sensor.

Preferably, the control apparatus is configured to execute, when performing variation abnormality detection,

(f) a step of calculating the output fluctuation parameter;

(g) a step of determining whether or not the calculated output fluctuation parameter is a value between a predetermined primary determination upper-limit value and a predetermined primary determination lower-limit value;

(h) a step of performing, on one cylinder with the most significant deviation of the air-fuel ratio, such forced active control as reduces the deviation of the air-fuel ratio when the calculated output fluctuation parameter is a value between the primary determination upper-limit value and the primary determination lower-limit value;

(i) a step of calculating the output fluctuation parameter while the forced active control is in execution; and

(j) a step of comparing the output fluctuation parameter calculated while the forced active control is in execution with a predetermined secondary determination value to determine whether or not a variation abnormality is present,

wherein the control apparatus executes the steps (a) to (e) when identifying the one cylinder with the most significant deviation of the air-fuel ratio in the step (h).

Preferably, the output waveform from the air-fuel ratio sensor is a periodic waveform with a period equal to one cycle of the internal combustion engine.

The present invention exerts an excellent effect that enables accurate discrimination between a lean-side deviation and a rich-side deviation.

Further features of the present invention will become apparent from the following description of exemplary embodiments (with reference to the attached drawings).

### BRIEF DESCRIPTION OF THE DRAWINGS

FIG. 1 is a schematic diagram of an internal combustion engine according to an embodiment of the present invention;

FIG. 2 is a graph depicting output characteristics of a pre-catalyst sensor and a post-catalyst sensor;

FIG. 3 is a graph depicting a fluctuation in exhaust air-fuel ratio in accordance with the degree of an inter-cylinder variation in air-fuel ratio;

FIG. 4 is a graph depicting a transition of output from the pre-catalyst sensor with respect to a crank angle;

FIG. 5 is a is a graph depicting a relation between an imbalance rate and an output fluctuation parameter;

FIG. 6 is a graph depicting output waveforms from the pre-catalyst sensor when a rich-side deviation occurs and when a lean-side deviation occurs, in an ideal state;

FIG. 7 is a graph depicting output waveforms from the pre-catalyst sensor when a rich-side deviation occurs and when a lean-side deviation occurs, in an actual state;

FIG. 8 is a graph depicting the relation between a slope difference and the imbalance rate;

FIG. 9 is a graph depicting the relation between a determination index value and the imbalance rate;

FIG. 10 is a flowchart of a deviation direction determination process;

FIG. 11 is a map depicting the relation between the amount of air sucked and a correction coefficient;

FIG. 12 is a graph depicting the results of verification obtained when the slope difference is used;

FIG. 13 is a graph depicting the results of verification obtained when the determination index value is used;

FIG. 14 is a schematic diagram depicting a configuration of a V6 engine;

FIG. 15 is a graph depicting output waveforms from the pre-catalyst sensor in the V6 engine;

FIG. 16 is a flowchart of an abnormal-cylinder identification process;

FIG. 17 is a graph illustrating a desired value for the imbalance rate;

FIG. 18 is a graph depicting characteristic lines obtained when the pre-catalyst sensor is a tolerance upper-limit article and when the pre-catalyst sensor is a tolerance lower-limit article;

FIG. 19 is a graph depicting that a detection-needed imbalance rate Bz is 60(%) in a comparative example;

FIG. 20 is a graph depicting that the detection-needed imbalance rate Bz is 40(%) in a comparative example;

FIG. 21 is a graph illustrating a measure for the case in FIG. 20;

FIG. 22 is a graph illustrating a method for setting a primary determination upper-limit value, a primary determination lower-limit value, and a secondary determination value according to the present embodiment;

FIG. 23A is a table illustrating the imbalance rate obtained when forced active control is performed;

FIG. 23B is a table illustrating the imbalance rate obtained when the forced active control is not performed; and

FIG. 24 is a flowchart of a variation abnormality detection process.

### DESCRIPTION OF THE EMBODIMENTS

An embodiment of the present invention will be described below with reference to the attached drawings.

### I. Basic Configuration

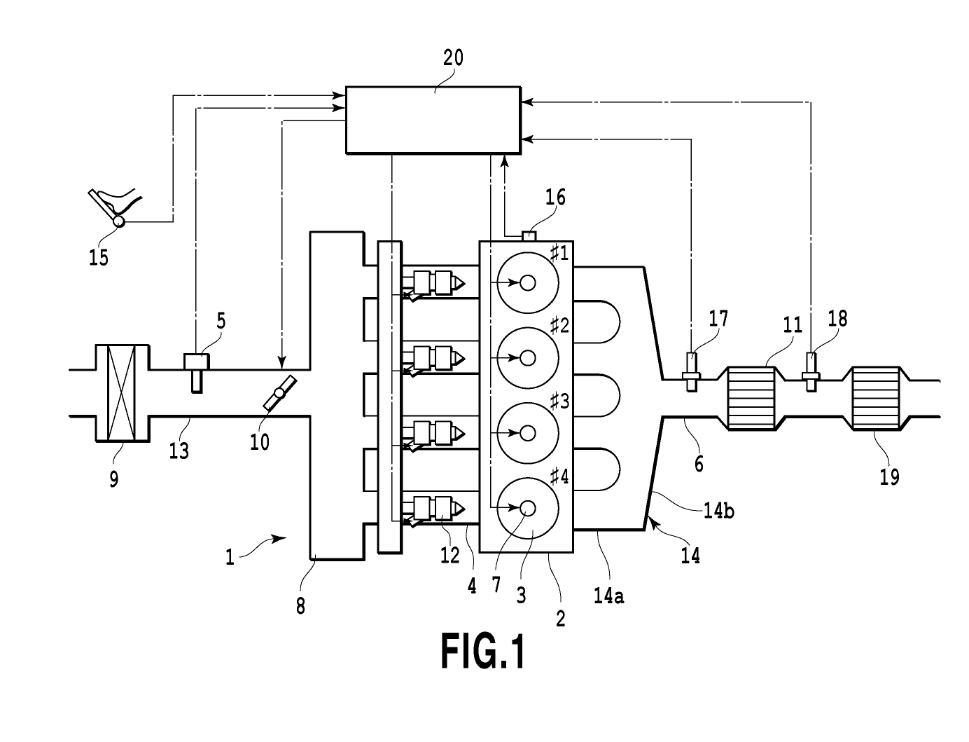

FIG. 1 is a schematic diagram of an internal combustion engine according to the present embodiment. An internal combustion engine (engine) 1 combusts a mixture of fuel and air inside a combustion chamber 3 formed in a cylinder block 2, and reciprocates a piston in the combustion chamber 3 to generate power. The internal combustion engine includes a plurality of cylinders, and according to the present embodiment, the internal combustion engine includes four cylinders #1 to #4. Furthermore, the internal combustion engine 1 according to the present embodiment is a multicylinder internal combustion engine mounted in a car, more specifically, an inline-four spark ignition internal combustion engine. The number of the cylinders, type, and the like in the internal combustion engine according to the present invention are not particularly limited. However, the number of cylinders is three or more.

Although not depicted in the drawings, a cylinder head of the internal combustion engine 1 includes intake valves each disposed at a corresponding cylinder to open and close a corresponding intake port and exhaust valves each disposed at a corresponding cylinder to open and close a corresponding exhaust port. Each intake valve and each exhaust valve are opened and closed by a cam shaft. The cylinder head includes ignition plugs 7 each attached to a top portion of the cylinder head for the corresponding cylinder to ignite the air-fuel mixture in the combustion chamber 3.

The intake port of each cylinder is connected, via a branch pipe 4 for the cylinder, to a surge tank 8 that is an intake air aggregation chamber. An intake pipe 13 is connected to an upstream side of the surge tank 8, and an air cleaner 9 is provided at an upstream end of the intake pipe 13. The intake pipe 13 incorporates an air flow meter 5 (intake air amount detection device) for detecting the amount of intake air and an electronically controlled throttle valve 10, the air flow meter 5 and the throttle valve 10 being arranged in order from the upstream side. The intake port, the branch pipe 4, the surge tank 8, and the intake pipe 13 form an intake passage.

Each cylinder includes an injector (fuel injection valve) 12 disposed therein to inject fuel into the intake passage, particularly the intake port. The fuel injected by the injector 12 is mixed with intake air to form an air-fuel mixture, which is then sucked into the combustion chamber 3 when the intake valve is opened. The air-fuel mixture is compressed by the piston and then ignited and combusted by the ignition plug 7. The injector may inject fuel directly into the combustion chamber 3.

On the other hand, the exhaust port of each cylinder is connected to an exhaust manifold 14. The exhaust manifold 14 includes a branch pipe 14a for each cylinder which forms an upstream portion of the exhaust manifold 14 and an exhaust aggregation section 14b forming a downstream portion of the exhaust manifold 14. An exhaust pipe 6 is connected to the downstream side of the exhaust aggregation section 14b. The exhaust port, the exhaust manifold 14, and the exhaust pipe 6 form an exhaust passage.

Furthermore, the exhaust passage located downstream of the exhaust aggregation section 14b of the exhaust manifolds 14 forms an exhaust passage common to the #1 to #4 cylinders that are the plurality of cylinders.

Catalysts each including a three-way catalyst, that is, an upstream catalyst 11 and a downstream catalyst 19, are arranged in series and attached to an upstream side and a downstream side, respectively, of the exhaust pipe 6. The catalysts 11 and 19 have an oxygen storage capacity (O₂ storage capability). That is, the catalysts 11 and 19 store excess air in exhaust gas to reduce NOx when the air-fuel ratio of exhaust gas is higher (leaner) than a stoichiometric ratio (theoretical air-fuel ratio, for example, A/F=14.6). Furthermore, the catalysts 11 and 19 emit stored oxygen to oxidize HC and CO in the exhaust gas when the air-fuel ratio of exhaust gas is lower (richer) than the stoichiometric ratio.

A first air-fuel ratio sensor and a second air-fuel ratio sensor, that is, a pre-catalyst sensor 17 and a post-catalyst sensor 18, are installed upstream and downstream, respectively, of the upstream catalyst 11 to detect the air-fuel ratio of exhaust gas. The pre-catalyst sensor 17 and the post-catalyst sensor 18 are installed immediately before and after the upstream catalyst, respectively, to detect the air-fuel ratio based on the concentration of oxygen in the exhaust. Thus, single pre-catalyst sensor 17 is installed at an exhaust junction on an upstream side of the upstream catalyst 11. The pre-catalyst sensor 17 corresponds to an “air-fuel ratio sensor” according to the present invention.

The ignition plug 7, the throttle valve 10, the injector 12, and the like are electrically connected to an electronic control unit (hereinafter referred to as an ECU) 20 serving as a control device or a control unit. The ECU 20 includes a CPU, a ROM, a RAM, an I/O port, and a storage device, none of which is depicted in the drawings. Furthermore, the ECU 20 connects electrically to, besides the above-described airflow meter 5, pre-catalyst sensor 17, and post-catalyst sensor 18, a crank angle sensor 16 that detects the crank angle of the internal combustion engine 1, an accelerator opening sensor 15 that detects the opening of an accelerator, and various other sensors via A/D converters or the like (not depicted in the drawings). Based on detection values from the various sensors, the ECU 20 controls the ignition plug 7, the throttle valve 10, the injector 12, and the like to control an ignition period, the amount of injected fuel, a fuel injection period, a throttle opening, and the like so as to obtain desired outputs.

The throttle valve 10 includes a throttle opening sensor (not depicted in the drawings), which transmits a signal to the ECU 20. The ECU 20 feedback-controls the opening of the throttle valve 10 (throttle opening) so as to make the actual throttle opening equal to a target throttle opening dictated according to the accelerator opening.

Based on a signal from the air flow meter 5, the ECU 20 detects the amount of intake air, that is, an intake flow rate, which is the amount of air sucked per unit time. The ECU 20 detects a load on the engine 1 based on at least one of the followings: the detected throttle opening and the amount of intake air.

Based on a crank pulse signal from the crank angle sensor 16, the ECU 20 detects the crank angle itself and the number of rotations of the engine 1. The “number of rotations” as used herein refers to the number of rotations per unit time and is used synonymously with rotation speed. According to the present embodiment, the number of rotations refers to the number of rotations per minute rpm.

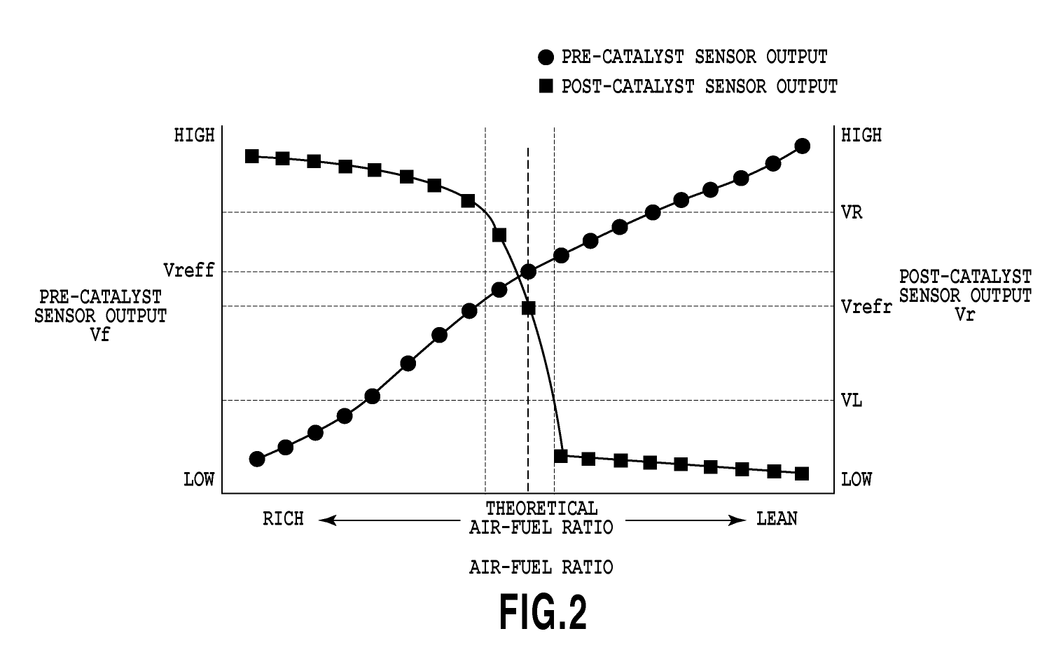

The pre-catalyst sensor 17 includes what is called a wide-range air-fuel ratio sensor and can consecutively detect a relatively wide range of air-fuel ratios. FIG. 2 depicts the output characteristic of the pre-catalyst sensor 17. As depicted in FIG. 2, the pre-catalyst sensor 17 outputs a voltage signal Vf of a magnitude proportional to an exhaust air-fuel ratio. An output voltage obtained when the exhaust air-fuel ratio is stoichiometric is Vreff (for example, 3.3 V).

On the other hand, the post-catalyst sensor 18 includes what is called an 0₂ sensor or an oxygen sensor and has a Z characteristic that an output value from the post-catalyst sensor 18 changes rapidly beyond the stoichiometric ratio. FIG. 2 depicts the output characteristic of the post-catalyst sensor. As depicted in FIG. 2, an output voltage obtained when the exhaust air-fuel ratio is stoichiometric, that is, a stoichiometrically equivalent value is Vrefr (for example, 0.45 V). The output voltage of the post-catalyst sensor 21 varies within a predetermined range (for example, from 0 V to 1 V). When the exhaust air-fuel ratio is leaner than the stoichiometric ratio, the output voltage of the post-catalyst sensor is lower than the stoichiometrically equivalent value Vrefr. When the exhaust air-fuel ratio is richer than the stoichiometric ratio, the output voltage of the post-catalyst sensor is higher than the stoichiometrically equivalent value Vrefr.

The upstream catalyst 11 and the downstream catalyst 19 simultaneously remove NOx, HC, and CO, which are harmful components in the exhaust, when the air-fuel ratio of exhaust gas flowing into each of the catalysts is close to the stoichiometric ratio. The range (window) of the air-fuel ratio within which the three components can be efficiently removed for purification at the same time is relatively narrow.

Thus, during normal operation, the ECU 20 performs air-fuel ratio feedback control so as to control the air-fuel ratio of exhaust gas discharged from the combustion chamber 3 and fed to the upstream catalyst 11 to the neighborhood of the stoichiometric ratio. The air-fuel ratio feedback control includes main air-fuel ratio control (main air-fuel ratio feedback control) that controls the amount of fuel injected to make the exhaust air-fuel ratio detected by the pre-catalyst sensor 17 equal to the stoichiometric ratio, a predetermined target air-fuel ratio and auxiliary air-fuel ratio control (auxiliary air-fuel ratio feedback control) that controls the amount of fuel injected to make the exhaust air-fuel ratio detected by the post-catalyst sensor 18 equal to the stoichiometric ratio.

The air-fuel ratio feedback control using the stoichiometric ratio as the target air-fuel ratio is referred to as stoichiometric control. The stoichiometric ratio corresponds to a reference air-fuel ratio. The stoichiometric uniformly corrects the amount of fuel injected for all the cylinders by the same value.

### II. Summary of Variation Abnormality Detection

For example, some of all the cylinders, particularly one cylinder, may become abnormal to cause a variation (imbalance) in the air-fuel ratio among the cylinders. For example, the injector 12 for the #1 cylinder may fail, and a larger amount of fuel may be injected in the #1 cylinder than by the remaining cylinders, the #2, #3, and #4 cylinders. Thus, the air-fuel ratio in the #1 cylinder may deviate significantly toward a rich side compared to the air-fuel ratios in the #2, #3, and #4 cylinders. Even in this case, the air-fuel ratio of total gas supplied to the pre-catalyst sensor 17, that is, the mean value of the air-fuel ratios in the cylinders, may be controlled to the stoichiometric ratio by performing the above-described stoichiometric control to apply a relatively large amount of correction. However, the air-fuel ratios of the individual cylinders are such that the air-fuel ratio in the #1 cylinder is much richer than the stoichiometric ratio, whereas and the air-fuel ratio in the #2, #3, and #4 cylinders are slightly leaner than the stoichiometric ratio. Thus, the air-fuel ratios are only totally in balance; only the total air-fuel ratio is stoichiometric. This is obviously not preferable for emission control. Thus, the present embodiment includes an apparatus that detects such an inter-cylinder air-fuel ratio variation abnormality.

An aspect of variation abnormality detection according to the present embodiment will be described below.

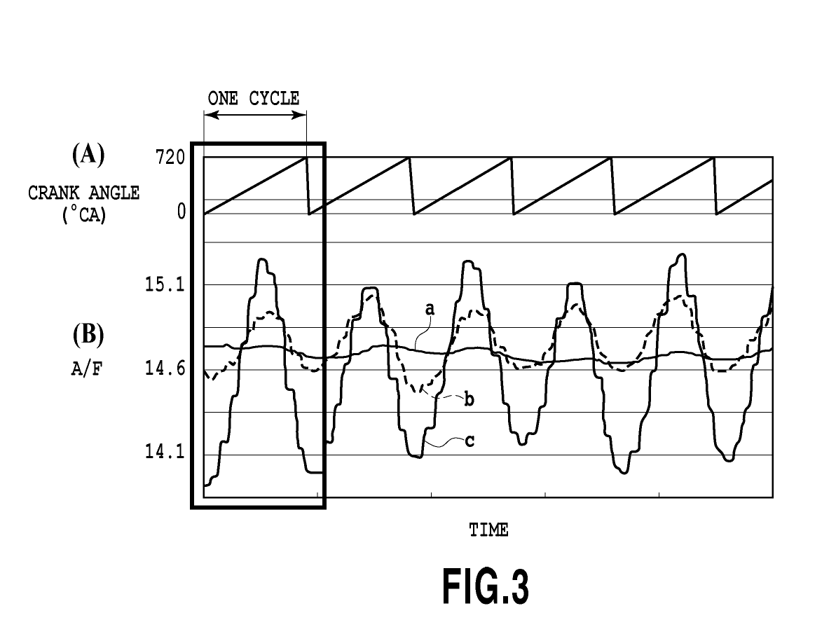

As depicted in FIG. 3, a variation in the air-fuel ratio among the cylinders increases a fluctuation in the exhaust air-fuel ratio. Air-fuel ratio lines a, b, c in (B) indicate air-fuel ratios detected by the pre-catalyst sensor 17 when no variation in air-fuel ratio occurs, when only one cylinder has a rich-side deviation at an imbalance rate of 20%, and when only one cylinder has a rich-side deviation at an imbalance rate of 50%, respectively. As seen in the air-fuel ratio lines, the amplitude of the variation in air-fuel ratio increases consistently with the degree of the variation among the cylinders.

The imbalance rate as used herein is a parameter correlated with the degree of the variation in air-fuel ratio among the cylinders. That is, the imbalance rate is a value representing the rate at which, if only one of all the cylinders has an air-fuel ratio deviating from the air-fuel ratio in the remaining cylinders, the air-fuel ratio in the cylinder with the air-fuel ratio deviation (imbalance cylinder) deviates from the air-fuel ratio in the cylinders with no air-fuel ratio deviation (balance cylinder). In the present embodiment, the imbalance rate is represented by Formula (1). An increase in imbalance rate B beyond 1 increases the deviation of the air-fuel ratio in the imbalance cylinder from the air-fuel ratio in the balance cylinder and the degree of the variation in air-fuel ratio.

$$B = \frac{A / Fb}{A / Fib} \qquad ( 1 )$$

A/Fb denotes the air-fuel ratio in the balance cylinder, and A/Fib denotes the air-fuel ratio in the imbalance cylinder. The imbalance rate is generally expressed in percentage. In this case, the imbalance rate B(%) is expressed by Formula (1)′. An increase in the absolute value of the imbalance rate B(%) increases the deviation of the air-fuel ratio in the imbalance cylinder from the air-fuel ratio in the balance cylinder and the degree of a variation in air-fuel ratio. The imbalance rate is hereinafter expressed in percentage unless otherwise noted.

$$B ( \% ) = \{ \frac{A / Fb}{A / Fib} - 1 \} \times 100 \qquad {( 1 )}^{′}$$

As is understood from FIG. 3, a fluctuation in the output from the pre-catalyst sensor 17 increases consistently with the absolute value of the imbalance rate B(%), that is, the degree of the variation in air-fuel ratio.

Hence, utilizing this characteristic, the present embodiment calculates or detects an output fluctuation parameter X that is a parameter correlated with the degree of the fluctuation in the output from the pre-catalyst sensor 17 to detect variation abnormality based on the calculated output variation parameter X.

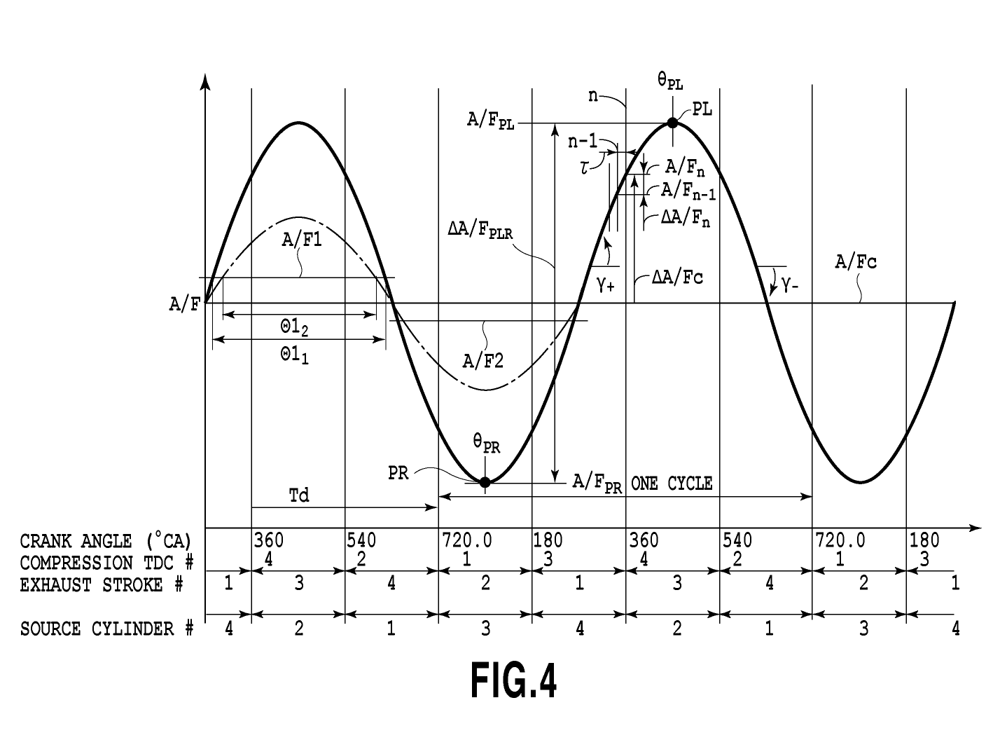

A method for calculating the output fluctuation parameter X will be described below. FIG. 4 depicts a transition of the pre-catalyst sensor output with respect to a crank angle. The crank angle is also referred to as a crank phase or simply a phase. The pre-catalyst sensor output may be the value of the air-fuel ratio A/F into which an output voltage Vf from the pre-catalyst sensor 17 is converted. However, the output voltage Vf from the pre-catalyst sensor 17 may be used directly as the pre-catalyst sensor output.

As depicted in FIG. 4, the pre-catalyst sensor output A/F varies at a period equal to one cycle of the engine (=720° CA; also referred to as one engine cycle). That is, an output waveform from the pre-catalyst sensor 17 is a periodic waveform with a period equal to one cycle of the engine. Furthermore, since the stoichiometric control is in execution, the output waveform from the pre-catalyst sensor 17 is a waveform varying substantially around the stoichiometric value.

As depicted in FIG. 4, the ECU 20 acquires the pre-catalyst sensor output A/F at each predetermined sample period T during one engine cycle. The ECU 20 then determines, from Formula (2) below, the absolute value of the difference between a value A/Fn acquired at the current (n) timing and a value A/Fn−1 acquired at the preceding (n−1) timing (the absolute value is hereinafter referred to as an output difference). The output difference ΔA/Fn may be referred to as an absolute value of a differential value or a slope obtained at the current timing.

ΔA/Fₙ=|A/Fₙ−A/Fₙ₋₁| (2)

Most simply stated, the output difference ΔA/Fn represents the magnitude of the fluctuation in the pre-catalyst sensor output. This is because the slope of an air-fuel ratio diagram and thus the output difference ΔA/Fn increase consistently with the degree of the fluctuation. Consequently, the value of the output difference ΔA/Fn at a predetermined timing can be used as the output fluctuation parameter.

However, for improved accuracy, the present embodiment uses the mean value of a plurality of output differences ΔA/Fn as the output fluctuation parameter. The present embodiment determines the output fluctuation parameter X by integrating the output difference ΔA/Fn at every sample period t during M engine cycles (M denotes an integer of 2 or more, for example, M=100) and dividing the final integrated value by the number of samples. The output fluctuation parameter X increases consistently with the degree of the fluctuation in pre-catalyst sensor output.

Any value correlated with the degree of the fluctuation in pre-catalyst sensor output can be used as the output fluctuation parameter. For example, the output fluctuation parameter may be calculated based on the difference between the lean-side (maximum) peak and rich-side (minimum) peak (what is called, a peak-to-peak value) of the pre-catalyst sensor output during one engine cycle or the absolute value of the maximum peak or minimum peak of a second-order differential value. This is because an increase in the degree of the fluctuation in pre-catalyst sensor output increases the difference between the lean-side peak and rich-side peak of the pre-catalyst sensor output and the absolute value of the maximum peak or minimum peak of the second-order differential value.

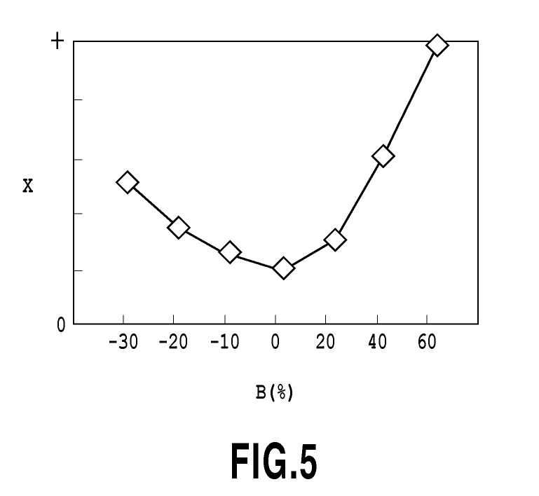

FIG. 5 depicts a relation between the imbalance rate IB (%) and the output fluctuation parameter X. As depicted in FIG. 5, the imbalance rate IB (%) and the output fluctuation parameter X have a strong correlation, and the output fluctuation parameter X tends to increase consistently with the absolute value of the imbalance rate IB.

Whether or not variation abnormality is present can be determined by comparing the calculated output fluctuation parameter X with a predetermined determination value α. For example, variation abnormality is determined to be present (abnormal) if the calculated output fluctuation parameter X is equal to or larger than the determination value α. Variation abnormality is determined to be absent (normal) if the calculated output fluctuation parameter X is smaller than the determination value α. As described below, the determination value α is set taking an OBD (On-Board Diagnosis) regulation value for exhaust emission.

### III. Deviation Direction Determination

When the air-fuel ratio varies, a possible cause is that the air-fuel ratios in some of the cylinders (particularly one cylinder) deviate toward the lean side or the rich side. Thus, enabling distinguishable determination of whether a lean- or rich-side deviation is occurring is desirable. Such determination is hereinafter referred to as “deviation direction determination”.

In this regard, Japanese Patent No. 5115657 discloses that whether a lean- or a rich-side deviation is occurring is determined by acquiring the positive and negative slopes of an output waveform from the air-fuel ratio sensor and comparing the positive and negative slopes in magnitude.

However, the results of studies conducted by the inventors indicate that it is not always possible to accurately determine whether a lean- or a rich-side deviation is occurring simply by comparing the positive and negative slopes in magnitude. This will be described below in detail.

First, before description of the deviation direction determination according to the present embodiment, a “positive slope value” and a “negative slope value” will be described which are parameters on which the deviation direction determination is based.

As depicted in FIG. 4, in an output waveform from the pre-catalyst sensor 17 during one engine cycle, a positive slope value S₊ is a value indicative of the magnitude of a slope γ₊ observed when an output from the pre-catalyst sensor 17 changes toward the lean side (increase side). A negative slope value S₋ is a value indicative of the magnitude of a slope γ₋ observed when the output from the pre-catalyst sensor 17 changes toward the rich side (decrease side).

Preferably, the positive slope value S₊ is a value resulting from integration, over one engine cycle, of a pre-catalyst sensor output difference (A/Fₙ−A/Fₙ₋₁)₊ between sample periods τ with positive values, or the mean of the integral values over M engine cycles. Likewise, the negative slope value S₋ is a value resulting from integration, over one engine cycle, of a pre-catalyst sensor output difference (A/Fₙ−A/Fₙ₋₁), between sample periods τ with negative values, or the mean of the integral values over M engine cycles. The embodiment uses the mean value over M engine cycles. In this case, the positive slope value S₊ and the negative slope value S₋ are expressed as follows.

$$\begin{matrix}{S}_{+} = \frac{\sum {( A / {F}_{n} - A / {F}_{n - 1} )}_{+}}{M} & ( 3 ) \\ {S}_{-} = \frac{\vert \sum {( A / {F}_{n} - A / {F}_{n - 1} )}_{-} \vert}{M} & ( 4 )\end{matrix}$$

In Formula (3), the denominator of the right side represents the final integral value or sum of the positive pre-catalyst sensor output differences (A/Fₙ−A/Fₙ₋₁)₊ over M engine cycles. Likewise, in Formula (4), the denominator of the right side represents the final integral value or sum of the negative pre-catalyst sensor output differences (A/Fₙ−A/Fₙ₋₁)₋ over M engine cycles. It should be noted that the negative slope value S₋ is expressed in absolute value form (in other words, the negative slope value S₋ is treated as a positive value) because the negative slope value S₋ expresses the magnitude of the slope γ₋.

Alternatively, the positive slope value S₊ may be an in-cycle mean value obtained by dividing, by the number of samples, a value resulting from integration of the positive pre-catalyst sensor output differences (A/Fₙ−A/Fₙ₋₁)₊ over one engine cycle, or the mean of the in-cycle mean values over M engine cycles. Likewise, the negative slope value S₋ may be the absolute value of an in-cycle mean value obtained by dividing, by the number of samples, a value resulting from integration of the negative pre-catalyst sensor output differences (A/Fₙ−A/Fₙ₋₁)₋ over one engine cycle, or the mean of the in-cycle mean values over M engine cycles.

Alternatively, the positive slope value S₊ may be the maximum value of the positive pre-catalyst sensor output difference (A/Fₙ−A/Fₙ₋₁)₊ during one engine cycle, or the mean of the maximum values over M engine cycles. Likewise, the negative slope value S₋ may be the absolute value of the minimum value of the negative pre-catalyst sensor output difference (A/Fₙ−A/Fₙ₋₁)₋ during one engine cycle, or the mean of the absolute values over M engine cycles. In this case, the sample period τ is preferably relatively long. This is to prevent microscopic oscillating components of the output from the pre-catalyst sensor from being reflected in the maximum value or the minimum value.

For the deviation direction determination, whether a lean-side deviation or a rich-side deviation is occurring may be determined simply by comparing the positive slope value S₊ with the negative slope value S₋ in magnitude. This determination is hereinafter referred to as a “normal method” for convenience. For example, when the positive slope value S₊ is larger than the negative slope value S₋, the apparatus determines that a lean-side deviation is occurring. When the negative slope value S₋ is larger than the positive slope value S₊, the apparatus determines that a rich-side deviation is occurring. However, the normal method is not always able to achieve accurate deviation direction determination. The reason will be described below.

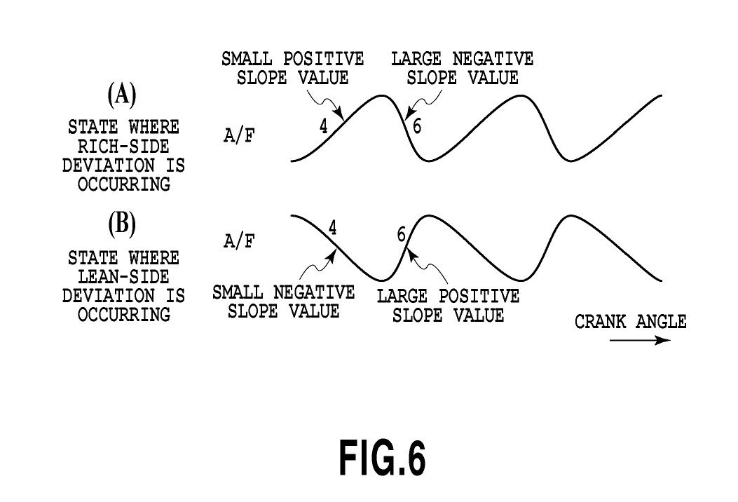

FIG. 6 depicts ideal output waveforms from the pre-catalyst sensor obtained when a rich-side deviation occurs and when a lean-side deviation occurs. Such a state as depicted in FIG. 6 is hereinafter referred to as an “ideal state”. FIG. 6(A) indicates a state where a rich-side deviation is occurring, and FIG. 6(B) indicates a state where a lean-side deviation is occurring.

As depicted, an output waveform resulting from a rich-side deviation and an output waveform resulting from a lean-side deviation are vertically symmetric. In other words, the output waveform resulting from a lean-side deviation has a shape obtained by turning the output waveform resulting from a rich-side deviation upside down. When a rich-side deviation occurs, the negative slope value S₋ increases above the positive slope value S₊ due to rich gas from a cylinder with the rich-side deviation. In contrast, when a lean-side deviation occurs, the positive slope value S₊ increases above the negative slope value S₋ due to lean gas from a cylinder with the lean-side deviation. For example, when a rich-side deviation occurs, the negative slope value S₋ has a value of 6, and the positive slope value S₊ has a value of 4. When a lean-side deviation occurs, the positive slope value S₊ has a value of 6, and the negative slope value S₋ has a value of 4.

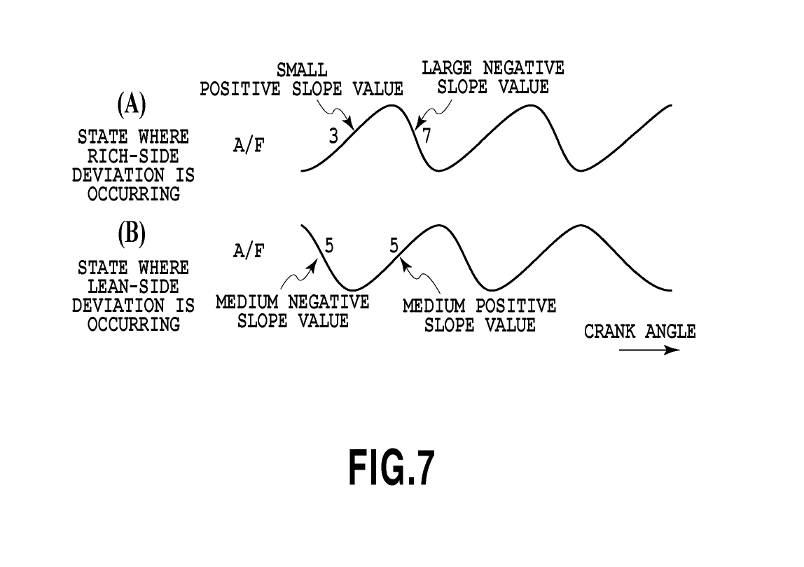

However, in actuality, the output waveforms may not be as in the ideal state but be in such a state as depicted in FIG. 7. This state is hereinafter referred to as an “actual state”.

As depicted, the waveform resulting from a rich-side deviation and the waveform resulting from a lean-side deviation are not vertically symmetric or in an upside-down form. Rather, the waveforms in the actual state tend to have a larger negative slope value S₋ and a smaller positive slope value S₊ than the waveforms in the ideal state. For example, the waveforms in the actual state have a negative slope value S₋ of 7 and a positive slope value S₊ of 3 when a rich-side deviation occurs, and have a positive slope value S₊ of 5 and a negative slope value S₋ of 5 when a lean-side deviation occurs.

This is because the pre-catalyst sensor 17 characteristically responds more quickly when the output from the pre-catalyst sensor 17 changes toward the rich side than when the output changes toward the lean side. Another cause may be a variation in the operating status of the engine (for example, the number of rotations, load, and temperature).

In the actual state, no problem results from a rich-side deviation. This is because the rich-side deviation results only in the emphasis of the characteristic that the negative slope value S₋ is larger than the positive slope value S₊. However, a problem results from a lean-side deviation. This is because the lean-side deviation undermines the characteristic that the positive slope value S₊ is larger than the negative slope value S. In fact, in the above-described example, the difference between the positive slope value S₊ and the negative slope value S₋ (S₊−S₋) is 2 (=6−4) in the ideal state but decreases to 0 (=5−5) in the actual state.

Thus, with a variation in the operating status of the engine and the like taken into account, the positive slope value S₊ may be smaller than the negative slope value S₋ even when a lean-side deviation occurs, leading to erroneous determination of the occurrence of a rich-side deviation.

Thus, to allow accurate deviation direction determination to be achieved to suppress such erroneous determination, the present embodiment allows the deviation direction to be determined based on a parameter as described below.

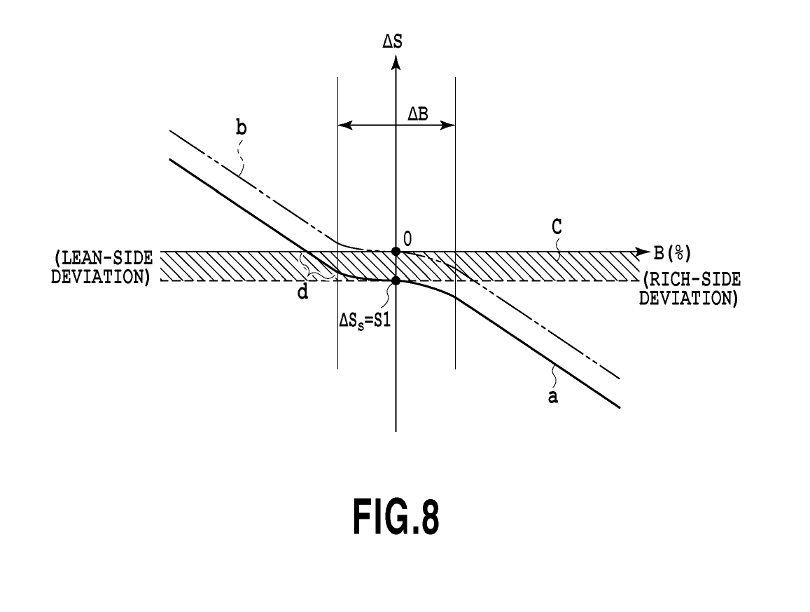

First, the parameter according to the present embodiment uses the slope difference ΔS between the positive slope value S₊ and the negative slope value S₋, particularly the slope difference ΔS=S₊−S₋ obtained by subtracting the negative slope value S₋ from the positive slope value S₊. The relation between the slope difference ΔS and the imbalance rate B(%) is as depicted by a characteristic line (a) in FIG. 8.

As depicted in FIG. 8, at an imbalance rate B of 0, the air-fuel ratio is prevented from varying, thus preventing a possible deviation of the air-fuel ratio in a certain cylinder. The amount of rich-side deviation in a certain cylinder increases consistently with the imbalance rate B increasing from 0. The amount of rich-side deviation in the certain cylinder decreases consistently with the imbalance rate B decreasing from 0.

The slope difference ΔS tends to decrease with increasing imbalance rate B. It should be noted that, at B=0 (no deviation of the air-fuel ratio), the characteristic line (a) passes through the corresponding point on ΔS=ΔS1 (<0) instead of the corresponding point on ΔS=0. In other words, even when no deviation of the air-fuel ratio occurs, the slope difference ΔS takes a negative value of ΔS1, and with respect to ΔS1, serving as a start point, ΔS decreases with increasing amount of rich-side deviation and increases with increasing amount of lean-side deviation.

Thus, a threshold ΔSs for the slope difference ΔS which allows the occurrence of a rich-side deviation or a lean-side deviation to be determined is preferably set equal to ΔS1 rather than to 0. This enables the deviation direction to be more accurately determined.

However, the present embodiment does not use the threshold ΔSs for the deviation direction determination. The characteristics of the threshold ΔSs are described herein only for reference. However, of course, it is possible to determine that a lean-side deviation is occurring when the slope difference ΔS is larger than the threshold ΔSs and that a rich-side deviation is occurring when the slope difference ΔS is smaller than the threshold ΔSs.

Now, the ideal state is assumed. Then, the relation between the slope difference ΔS and the imbalance rate B(%) in the ideal state is as depicted by a characteristic line (b). In this case, the characteristic line (b) corresponds to the characteristic line (a) translated toward larger ΔS values, and passes through a point of B=0 and ΔS=0 (origin). Hence, when the slope difference ΔS has a positive value larger than 0, the determination is that a lean-side deviation is occurring. When the slope difference ΔS has a negative value smaller than 0, the apparatus determines that a rich-side deviation is occurring. The threshold for the slope difference ΔS is 0. A comparison of the slope difference ΔS with 0 is the same as a comparison of the positive slope value S₊ and the negative slope value S₋ in magnitude. Such determination is not necessarily an optimum method as described above.

As understood, the present embodiment is characterized by setting the threshold ΔSs for the slope difference ΔS to, instead of 0, a negative value ΔS1, which is smaller than 0. The range of the slope difference ΔS from 0 to ΔS1 corresponds to an area in which the positive slope value S₊ is smaller than the negative slope value S₋ even though a lean-side deviation is actually occurring, leading to erroneous determination of the occurrence of a rich-side deviation.

A predetermined range ΔB of the imbalance rate approximately centered around B=0 in FIG. 8 represents the range within which the deviation direction determination is not performed because of a small degree of variation in air-fuel ratio in an example of variation abnormality detection described below. In effect, the characteristic line (a) except for this range is used to determine the deviation direction. The slope of the characteristic line (a) within the range ΔB tends to be smaller than the slope of the characteristic line (a) outside the range ΔB.

In particular, even outside the range ΔB, apart (d) of the lean-side deviation side of the characteristic line (a) lies within a range (c). Thus, the erroneous determination may occur in the part (d).

In a variation, the slope difference ΔS may be a difference resulting from subtraction of the positive slope value S₊ from the negative slope value S₋ (ΔS=S₋−S₊). Furthermore, instead of the slope difference ΔS₋ the ratio between the positive slope value S₊ and the negative slope value S₋, that is, a slope ratio Sr, may be used. The slope ratio Sr may be S₊/S₋ or S₋/S₊. It is apparent to those skilled in the art how the characteristics depicted in FIG. 8 are changed by the above-described variations. For example, when the slope ratio Sr=S₊/S₋ is used, the negative slope value ΔSs=ΔS1 is changed to a threshold Srs that is larger than 0 and smaller than 1. Then, the slope ratio Sr smaller than the threshold Srs is determined to indicate that a rich-side deviation is occurring. The slope ratio Sr larger than the threshold Srs is determined to indicate that a lean-side deviation is occurring.

Next, the parameter according to the present embodiment is a value resulting from division of the slope difference ΔS by an amplitude index value indicative of the magnitude of the maximum amplitude of an output waveform from the pre-catalyst sensor 17. The value is hereinafter referred to as a “determination index value” and denoted by reference character W. The determination index value W is a parameter directly used to determine the deviation direction according to the present embodiment.

The division of the slope difference ΔS by the amplitude index value is performed in order to normalize the slope difference ΔS. That is, an increased imbalance rate B increases the maximum amplitude of the output waveform from the pre-catalyst sensor 17 (see FIG. 3), both the positive slope value S₊ and the negative slope value S₋, and the slope difference ΔS.

For example, it is assumed that, at a certain imbalance rate B, the positive slope value S₊ is 6 and the negative slope value S₋ is 4. It is then assumed that an increase in imbalance rate B has increased both the positive slope value S₊ and the negative slope value S₋ by 50%; the positive slope value S₊ has changed to 9, and the negative slope value has changed to 6. Then, the former slope difference ΔS is 6−4=2, and the latter slope difference ΔS is 9−6=3. The slope difference ΔS also increases by 50%.

Normalization is performed in order to compensate for or cancel a change in slope difference ΔS resulting from a change in imbalance rate B. Thus, the accuracy of the deviation direction determination is further improved, enabling the deviation direction to be more accurately determined. This will be described below in detail.

Now, the “amplitude index value” will be described. As depicted in FIG. 4, the amplitude index value is a value correlated with the magnitude of the maximum amplitude with respect to a center air-fuel ratio A/Fc in the output waveform from the pre-catalyst sensor 17 at least during one engine cycle. The amplitude index value is denoted by reference character A. The magnitude of the maximum amplitude as used herein refers to the amount of displacement of a lean-side peak PL or a rich-side peak PL from the center air-fuel ratio A/Fc or the distance from the center air-fuel ratio A/Fc to the lean-side peak PL or the rich-side peak PR. For example, the magnitude of the maximum amplitude refers to the difference between the air-fuel ratio A/F_{PL} at the lean-side peak PL and the center air-fuel ratio A/Fc (A/F_{PL}−A/Fc) or the difference between the air-fuel ratio A/F_{PR} at the rich-side peak PR and the center air-fuel ratio A/Fc (A/Fc−A/F_{PR}). The center air-fuel ratio A/Fc may be the moving average value of the sensor output waveform. Alternatively, the center air-fuel ratio A/Fc has a value close to the stoichiometric value during stoichiometric control, and thus, the center air-fuel ratio A/Fc may be a given value or a fixed value equal to the stoichiometric value.

Preferably, the amplitude index value A is the sum of the positive slope value S₊ and the negative slope value S. The positive slope value S₊ and the negative slope value S₋ increase consistently with the maximum amplitude of the sensor output waveform. Thus, the present embodiment uses the sum as the amplitude index value A. The sum is the mean value over M engine cycles as is apparent from Formulae (3) and (4) described above, but may be a value within one engine cycle. The amplitude index value A according to the present embodiment is expressed by:

A=S₊+S₋ (5)

Thus, the determination index value W according to the present embodiment is expressed by:

$$W = \frac{Δ S}{A} = \frac{{S}_{+} - {S}_{-}}{{S}_{+} + {S}_{-}} \qquad ( 6 )$$

Alternatively, the amplitude index value A may be the difference ΔA/F_{PLR}=A/F_{PL}−A/F_{PR} (what is called peak-to-peak) between the air-fuel ratio A/F_{PL} at the lean-side peak PL and the air-fuel ratio A/F_{PR} at the rich-side peak PR during one engine cycle, or the mean value of the differences over M engine cycles. This is because the difference ΔA/F_{PLR} increases consistently with the amplitude of the sensor output waveform.

Alternatively, the amplitude index value A may be the sum M=M1+M2 of an area M1 enclosed by the center air-fuel ratio A/Fc and the waveform on the lean side of the center air-fuel ratio A/Fc and an area M2 enclosed by the center air-fuel ratio A/Fc and the waveform on the rich side of the center air-fuel ratio A/Fc, during one engine cycle, or the mean value of the sums over M engine cycles. This is because the sum M increases consistently with the amplitude of the sensor output waveform. The sum M may be calculated by integrating the absolute value of the difference ΔA/Fₙ−A/Fc between the pre-catalyst sensor output A/Fₙ and the center air-fuel ratio A/Fc at every sample period i.

Alternatively, the amplitude index value A may be the simple mean value (S₋ +S₊)/2 of the positive slope value S₊ and the negative slope value S₋, or the mean square value √(S₊²+S₋²), or the mean of these values over M engine cycles.

Alternatively, the amplitude index value A may be a value described below or the mean of that value over M engine cycles. That is, as depicted in FIG. 4, a lean-side set air-fuel ratio A/F1 and a rich-side set air-fuel ratio A/F2 are preset which are displaced slightly toward the lean and rich sides, respectively, of the center air-fuel ratio A/Fc. The set air-fuel ratios A/F1 and A/F2 are relatively close to the center air-fuel ratio A/Fc. Then, at least one of periods of time θ1 and θ2 is calculated; during the period of time θ1, the output waveform lies on the lean side of the lean-side set air-fuel ratio A/F1, and during the period of time θ2, the output waveform lies on the rich side of the rich-side set air-fuel ratio A/F2. The amplitude index value A can be defined based on at least one of the periods of time θ1 and θ2.

For example, only the lean side is focused on in the following description. An output waveform with a large maximum amplitude depicted by a solid line in FIG. 4 has a period of time θ1₁. An output waveform with a small maximum amplitude depicted by an imaginary line in FIG. 4 has a period of time θ1₂, and θ1₁>θ1₂. Hence, the period θ1 is also correlated with the magnitude of the maximum amplitude of the sensor output waveform and can be independently used as the amplitude index value A.

Similarly, the period θ2 can be independently used as the amplitude index value A. When both the period θ1 and the period θ2 are used, for example, the sum, simple mean value, or mean square value of the period θ1 and the period θ2 may be used as the amplitude index value A.

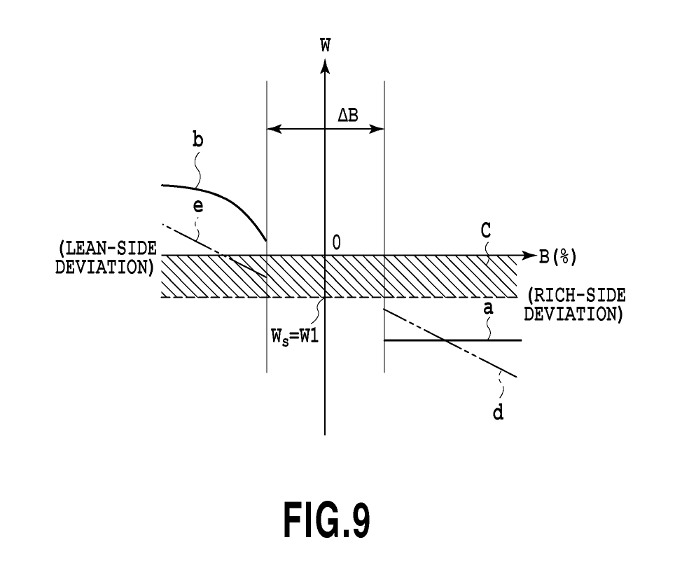

In FIG. 9, characteristic lines (a) and (b) indicate the relation between the imbalance rate B(%) and the determination index value W resulting from normalization of the slope difference ΔS through division by the amplitude index value A.

In the example depicted in FIG. 9, the characteristic lines (a) and (b) are discontinuous. This is because data on the above-described ΔB is omitted. Of course, the characteristic lines may be defined so as to include the data on the range ΔB.

In an area having a larger imbalance rate B than the range ΔB, in other words, in a rich-side deviation-side area, the determination index value W tends to be constant as depicted by the characteristic line (a). Furthermore, in an area having a smaller imbalance rate B than the range ΔB, in other words, in a lean-side deviation-side area, the determination index value W tends to increase curvedly with the imbalance rate B decreasing, as depicted by the characteristic line (b). Advantageously, the characteristic line (a) and the characteristic line (b) are as far away from each other as possible in the direction of the axis of ordinate.

A negative value W1 for the determination index value W corresponds to the negative value ΔS1 for the slope difference ΔS depicted in FIG. 8. In other words, the range (c) of the determination index value W from 0 to W1 corresponds to an area in which the occurrence of a rich-side deviation is erroneously determined even though a lean-side deviation is actually occurring.

However, the characteristic lines (a) and (b) depicted in FIG. 9 do not fall within the range (c) but are rather positioned away from the range (c) compared to the characteristic line (a) depicted in FIG. 8. In particular, the part (d) of the characteristic line (a) depicted in FIG. 8 falls within the range (c) but no part of the characteristic line (b) depicted in FIG. 9 lies within the range (c). This enables further improvement of the accuracy of the deviation direction determination to avoid such an erroneous determination as described above.

The embodiment involves determining, based on the determination index value W, whether or not the deviation of the air-fuel ratio in one cylinder with the most significant deviation of the air-fuel ratio is a lean-side deviation or a rich-side deviation (that is, determining the deviation direction). Specifically, a comparison of the determination index value W with a predetermined threshold Ws is made to determine that a rich-side deviation is occurring when the determination index value W is smaller than the threshold Ws and that a lean-side deviation is occurring when the determination index value W is larger than the threshold Ws.

To allow such determination to be accurately made, the threshold Ws is preferably set to be an intermediate value between the maximum value on the rich-side characteristic line (a) and the minimum value on the lean-side deviation (b). In other words, the threshold Ws is preferably set equal to the determination index value W when the determination index value W lies farthest from both the rich-side characteristic line (a) and the lean-side characteristic line (b). Thus, in view of such characteristics as depicted in FIG. 9, the threshold Ws is set equal to a negative value W1 defining the range (c) according to the present embodiment. However, the threshold Ws may be set to a different value.

For reference, characteristic lines (d) and (e) of unnormalized slope difference ΔS are depicted by imaginary lines. The characteristic lines (d) and (e) correspond to the characteristic line (a) shown in FIG. 8 (however, the characteristic lines (d) and (e) are not to scale).

In the above-described example, the occurrence of a rich-side deviation is erroneously determined when a lean-side deviation is occurring. However, the opposite case is possible. That is, the occurrence of a lean-side deviation is erroneously determined when a rich-side deviation is occurring. This is because the pre-catalyst sensor 17 may have characteristics opposite to the above-described characteristics (the positive slope value S₊ is larger than the corresponding value in the ideal state, and the negative slope value S₋ is smaller than the corresponding value in the ideal state), or tendencies opposite to the above-described tendencies may occur depending on a variation in the operating status of the engine or when the amount of deviation of the air-fuel ratio is small. The embodiment can deal with such cases and enables the deviation direction to be accurately determined to suppress the erroneous determination.

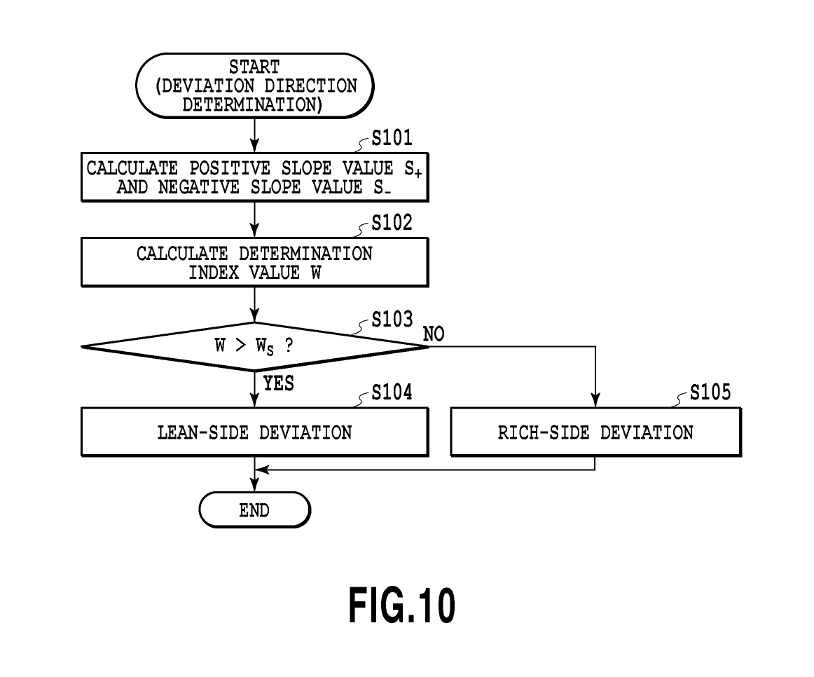

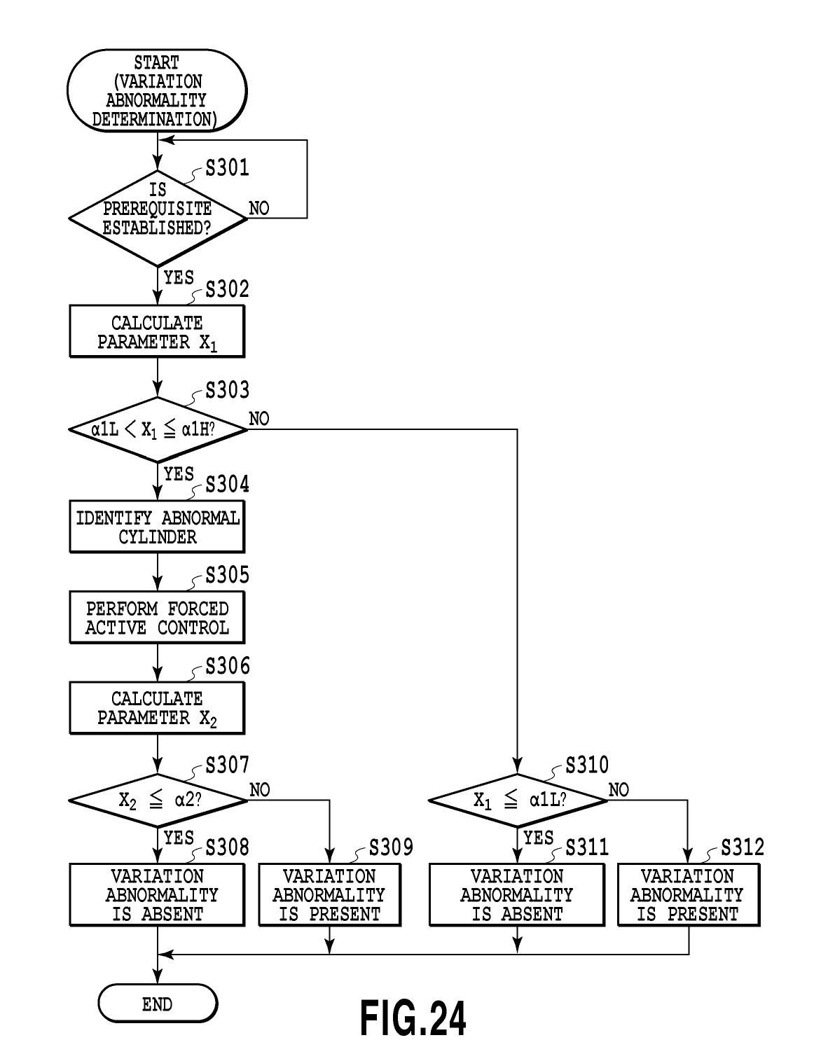

Now, a more specific deviation direction determination process according to the present embodiment will be described. The determination process is executed by the ECU 20 in accordance with such an algorithm as represented in a flowchart in FIG. 10. The determination process is preferably executed only when a prerequisite (step S301 in FIG. 24) for a variation abnormality detection process described below is established.

First, in step S101, the positive slope value S₊ and the negative slope value S₋ are calculated in accordance with Formulae (3) and (4). Then, in step S102, the determination index value W is calculated in accordance with Formula (6).

Then, in step S103, the determination index value W is compared with the threshold Ws. When the determination index value W is larger than the threshold Ws, the process proceeds to step S104 to determine the deviation of the air-fuel ratio in one cylinder with the most significant deviation of the air-fuel ratio to be a lean-side deviation. On the other hand, when the determination index value W is equal to or smaller than the threshold Ws, the process proceeds to step S105 to determine the deviation of the air-fuel ratio to be a rich-side deviation. For convenience, the deviation of the air-fuel ratio is determined to be a rich-side deviation when W=Ws. This poses no particular problem because, in this case, the imbalance rate is substantially 0 and the deviation direction determination is virtually rarely performed.

According to the present embodiment, in the calculation of the determination index value W, the slope difference ΔS is normalized by being divided by the amplitude index value A. However, due to a variation in the operating status of the engine and the like, the determination index value W is not necessarily optimally compatible with the threshold Ws, which is a preset value. Hence, the determination index value W or the threshold Ws is preferably corrected in accordance with the operating status of the engine. This correction is of course performed by the ECU 20.

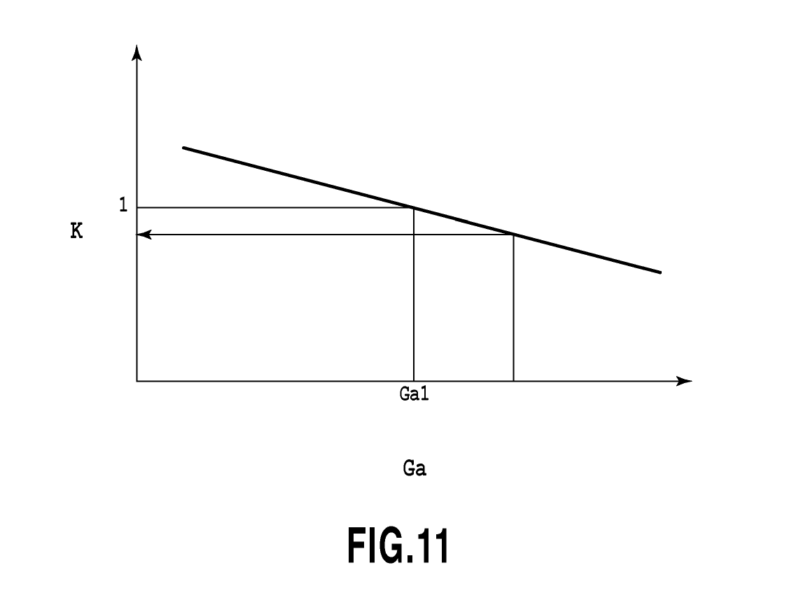

For example, when the threshold Ws is corrected in accordance with the amount of air sucked Ga, a correction coefficient K corresponding to the amount of air sucked Ga (detection value) is determined based on such a predetermined map as depicted in FIG. 11 (a function may be used instead of the map; this also applies to the description below). The reference threshold Ws is multiplied by the correction coefficient K to determine a corrected threshold Ws′=K×Ws. Then, in step S103, the corrected threshold Ws' is compared with the determination index value W.

In the map, the correction coefficient K tends to decrease with increasing amount of air sucked Ga. This is because the slope difference ΔS tends to decrease with increasing amount of air sucked Ga. Furthermore, the correction coefficient K is 1 at a predetermined reference amount of air sucked Gal. Hence, the threshold Ws is corrected so as to decrease with increasing amount of air sucked Ga. Of course, this manner of correction is preferably optimized in accordance with the tendency of the engine.

The correction allows improvement of robustness to a variation in the operating status of the engine and the like to further increase the determination accuracy.

For correction of the determination index value W, the determination index value W may be similarly corrected so as to increase consistently with the amount of air sucked Ga. Furthermore, the parameter indicative of the operating status of the engine may be other than the amount of air sucked Ga, and may be, for example, the number of rotations of the engine or the water temperature of the engine.

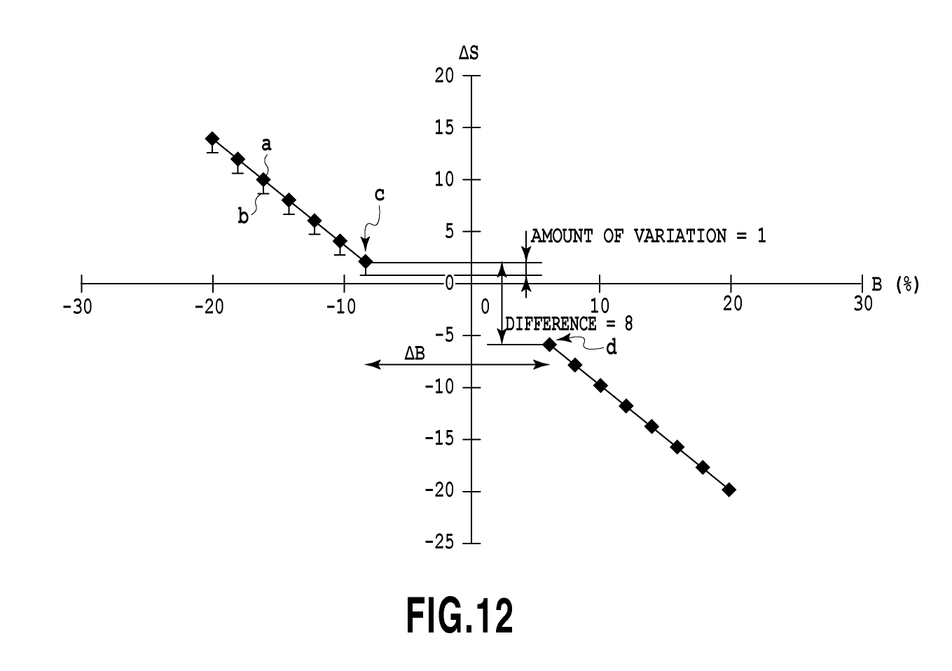

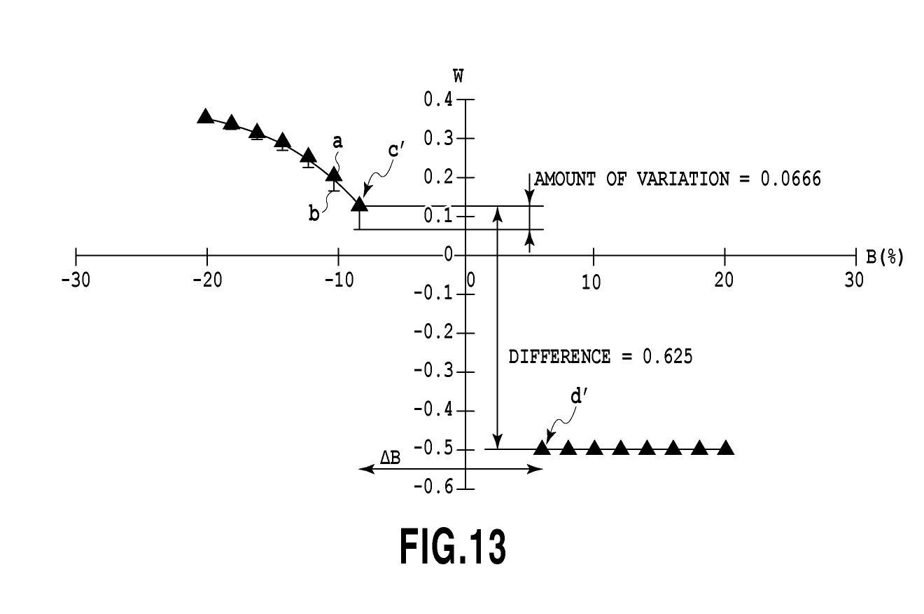

FIG. 12 and FIG. 13 depict the results of verification. FIG. 12 illustrates the use of the slope difference ΔS, which is an unnormalized parameter. FIG. 13 illustrates the use of the determination index value W, which is a normalized parameter. In FIG. 12 and FIG. 13, a plot (a) of data observed when the imbalance rate B(%) is negative represents the mean values of the variation range of data. The horizontal line (b) indicates the lower limit value of the variation range of data. The upper limit value is omitted. The range ΔB of the imbalance rate within which the deviation direction determination is not performed is −8%<B<+6%.

FIG. 12 illustrates the use of the slope difference ΔS. For data (c) located on the negative side of the imbalance rate B but closest to the positive side of the imbalance rate B, the amount of variation between the mean value and the lower limit value is 1. Furthermore, for data (c) and data (d) located on the positive side of the imbalance rate B but closest to the negative side of the imbalance rate B, the difference between the mean value of the data (c) and the mean value of the data (d) is 8. Thus, a value indicative of the adverse effect of the variation on the difference is ⅛=0.125=12.5%.

On the other hand, FIG. 13 illustrates the use of the determination index value W. For data (c′) located on the negative side of the imbalance rate B but closest to the positive side of the imbalance rate B, the amount of variation between the mean value and the lower limit value is 0.0666. Furthermore, for data (c′) and data (d′) located on the positive side of the imbalance rate B but closest to the negative side of the imbalance rate B, the difference between the mean value of the data (c′) and the mean value of the data (d′) is 0.625. Thus, the value indicative of the adverse effect of the variation on the difference is 0.0666/0.625=0.105=10.5%.

This verifies that the use of the determination index value W (normalized parameter) enables a 2% reduction in the adverse effect of the variation compared to the use of the slope difference ΔS (unnormalized parameter), improving robustness and the determination accuracy.

### IV. Abnormal-Cylinder Identification

The above-described deviation direction determination is very effective for identifying one cylinder with the most significant deviation of the air-fuel ratio (this cylinder is hereinafter referred to as an “abnormal cylinder” for convenience). Thus, an abnormal-cylinder identification method utilizing the deviation direction determination will be described.

The variation abnormality detection apparatus can desirably identify an abnormal cylinder that may cause variation abnormality. This is because, for example, information on the abnormal cylinder can be utilized for subsequent repairs and the like or emission limitation and the like can be achieved by performing certain control on the abnormal cylinder.

A possible method for identifying the abnormal cylinder is based on such a crank angle corresponding to the peak of the output waveform from the pre-catalyst sensor (the crank angle is hereinafter referred to as the “peak phase”) as depicted in FIG. 4.

However, the method based on the peak method needs to identify two cylinders because the peak phase includes a lean-side peak phase and a rich-side peak phase, and thus has difficulty identifying one abnormal cylinder.

Thus, according to the present embodiment, the method based on the peak phase is improved so as to identify one abnormal cylinder. An identification method according to the present embodiment will be described below, but before the description, an identification method in a comparative example based on the peak phase will be described.

As depicted in FIG. 4, one cycle in the engine ranges from 0° CA to 720° CA. In the present embodiment, at 0° CA, the #1 cylinder is at a compression top dead center (compression TDC). At 180° CA, the 3 cylinder is at the compression top dead center. At 360° CA, the 4 cylinder is at the compression top dead center. At 540° CA, the 2 cylinder is at the compression top dead center. In other words, ignition occurs in the following order: #1, #3, #4, and #2.

In this case, between 0° CA and 180° CA, the #2 cylinder is in an exhaust stroke. Between 180° CA and 360° CA, the #1 cylinder is in the exhaust stroke. Between 360° CA and 540° CA, the #3 cylinder is in the exhaust stroke. Between 540° CA and 720° CA, the #4 cylinder is in the exhaust stroke.

Time delay caused by transportation delay, response delay, or the like may occur before exhaust gas discharged from the combustion chamber 3 is actually detected by the pre-catalyst sensor 17. This delay time is denoted as Td. In the illustrated example, Td=360° CA for convenience. However, the length of the delay time Td varies according to the engine individual, the operating status of the engine, or the like.

For Td=360° CA, a source cylinder for exhaust gas detected by the pre-catalyst sensor 17 at each crank angle is as depicted in FIG. 4. For example, during a crank angle period between 0° and 180°, the source cylinder is #3, and exhaust gas discharged from the #3 cylinder is detected by the pre-catalyst sensor 17.

As indicated by the output waveform from the pre-catalyst sensor in the illustrated example, the source cylinder is #2 at the lean-side peak phase θ_{PL} and is #3 at the rich-side peak phase θ_{PR}. The interval between the lean-side peak phase θ_{PL} and the rich-side peak phase θ_{PR} is approximately equal to ½ engine cycle (=360° CA). Thus, the method in the comparative example identifies the #2 and #3 cylinders as two cylinders each estimated to have a deviation of the air-fuel ratio. The two cylinders are hereinafter referred to as “estimated abnormal cylinders” for convenience. In particular, the #2 cylinder is likely to have a lean-side deviation or the #3 cylinder is likely to have a rich-side deviation. Hence, the #2 cylinder is identified as a lean estimated abnormal cylinder estimated to have a lean-side deviation of the air-fuel ratio. The #3 cylinder is identified as a rich estimated abnormal cylinder estimated to have a rich-side deviation of the air-fuel ratio. As described above, the two cylinders are identified as estimated abnormal cylinders in association with the two peaks of the output waveform from the sensor.

However, the method in the comparative example poses the following problems. That is, although the two estimated abnormal cylinders, the lean estimated abnormal cylinder and the rich estimated abnormal cylinder, are identified which are treated as candidates for the abnormal cylinder, further identification, limitation, or narrowing-down is difficult. Since the output waveform from the pre-catalyst sensor 17 has a period equal to one cycle of the engine as described above, one of the cylinders, the lean estimated abnormal cylinder, and the other cylinder, the rich estimated abnormal cylinder, tend to provide opposite cylinders spaced at a combustion interval or a compression top dead center interval equal to a half cycle of the engine (=360° CA). Then, as described above, a distinction fails to be made between the #2 cylinder as the lean estimated abnormal cylinder (hereinafter also referred to as “#2 lean”) and the #3 cylinder as the rich estimated abnormal cylinder (#3 rich). Thus, determining which of the cylinders is the abnormal cylinder is difficult. Other combinations of estimated abnormal cylinders that are difficult to identify include a combination of #1 rich and #4 lean, a combination of #2 rich and #3 lean, an a combination of #1 lean and #4 rich. At most one of these four patterns can be identified, but one of the cylinders in that pattern is difficult to identify.

However, utilization of the deviation direction determination according to the present embodiment enables one of the cylinders in one pattern to be identified. That is, since the deviation direction determination allows determination of whether the deviation of the air-fuel ratio in the abnormal cylinder is a lean-side deviation or a rich-side deviation, the result of the deviation direction determination can be utilized to determine either the lean estimated abnormal cylinder or the rich estimated abnormal cylinder to be the abnormal cylinder. When the result of the deviation direction determination is a lean-side deviation, the lean estimated abnormal cylinder is identified as the abnormal cylinder. When the result of the deviation direction determination is a rich-side deviation, the rich estimated abnormal cylinder is identified as the abnormal cylinder. Thus, the abnormal cylinder can be suitably identified by utilizing the deviation direction determination.

When one of the estimated abnormal cylinders is determined to be the abnormal cylinder, the other estimated abnormal cylinder is indirectly determined not to be the abnormal cylinder.

The deviation of the air-fuel ratio in the abnormal cylinder includes a relatively significant deviation of the air-fuel ratio and a relatively insignificant deviation of the air-fuel ratio. When a relatively significant deviation of the air-fuel ratio is occurring, variation abnormality detection desirably results in determination of the presence of variation abnormally. On the other hand, when only a relatively insignificant deviation of the air-fuel ratio is occurring, the presence of variation abnormality may not necessarily be determined in association with an OBD regulation value. In this case, the abnormal cylinder is not necessarily abnormal, but it should be noted that the term “abnormal cylinder” is a term used for convenience.

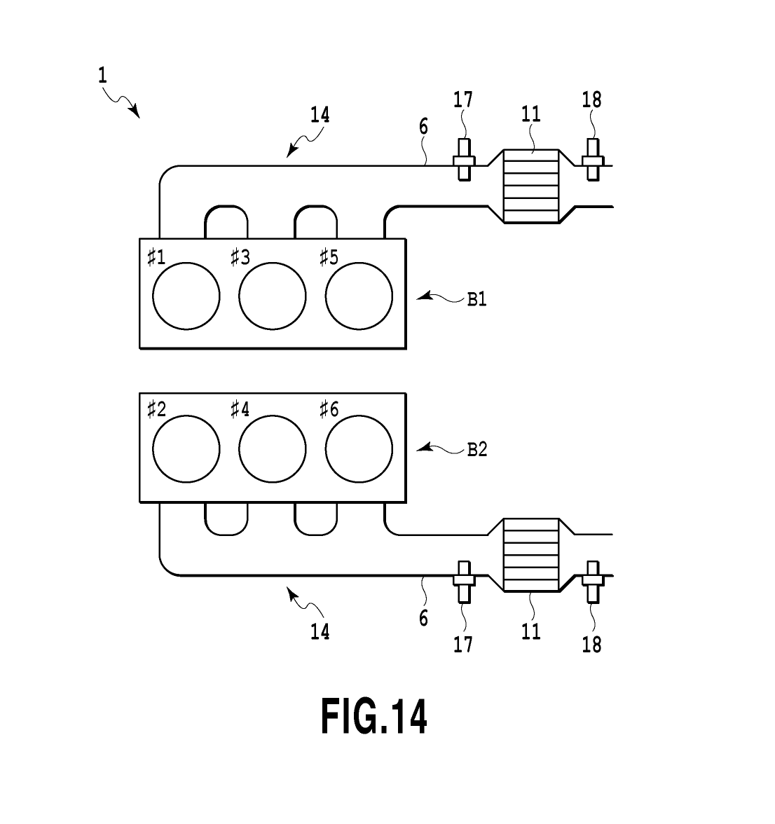

A variation will be described in which the abnormal cylinder identification method according to the present embodiment is applied to a V6 engine. A configuration of the engine is as depicted in FIG. 14. The engine 1 has a first bank (for example, a right bank) B1 and a second bank (for example, a left bank) B2. The first bank B1 is provided with a #1 cylinder, a #3 cylinder, and a #5 cylinder, whereas the second bank B2 is provided with a #2 cylinder, a #4 cylinder, and a #6 cylinder. Each of the banks is provided with an exhaust manifold 14, an exhaust pipe 6, an upstream catalyst 11, a pre-catalyst sensor 17, and a post-catalyst sensor 18. The exhaust pipes 6 of the banks are merged together on a downstream side not depicted in FIG. 14. On a downstream side of the position of the merger, a downstream catalyst 19 common to the banks is provided. Although not depicted in the drawings, the remaining part of the configuration is the same as the corresponding part of the inline-four engine depicted in FIG. 1 and will not be described below in detail. In the V6 engine 1, on the first bank B1 side, the air-fuel ratio sensor, that is, the pre-catalyst sensor 17, is installed on an exhaust passage common to the three cylinders, the #1 cylinder, the #3 cylinder, and the #5 cylinder. Similarly, on the second bank B2 side, the air-fuel ratio sensor, that is, the pre-catalyst sensor 17, is installed on an exhaust passage common to the three cylinders, the #2 cylinder, the #4 cylinder, and the #6 cylinder.

In this engine, the above-described air-fuel ratio control, variation abnormality detection, and abnormal cylinder identification process are independently executed on each of the banks. That is, control and processing similar to control and processing for the inline-four engine are executed on each bank. Thus, for example, for the first bank B1 side, the three cylinders #1, #3, and #5 are collectively treated like one inline-three engine. Control and processing similar to the control and processing for the inline-four engine are executed on this inline-three engine. This also applies to the second bank B2 side.

In this case, for example, for the first bank B1 side, ignition in the cylinder occurs in the following order: the #1 cylinder, the #3 cylinder, and the #5 cylinder. The combustion interval or compression top dead center interval between the #1 cylinder and the #3 cylinder and the #5 cylinder is 240° CA. Hence, the #1 cylinder, the #3 cylinder, and the #5 cylinder do not provide opposite cylinders in any combination.

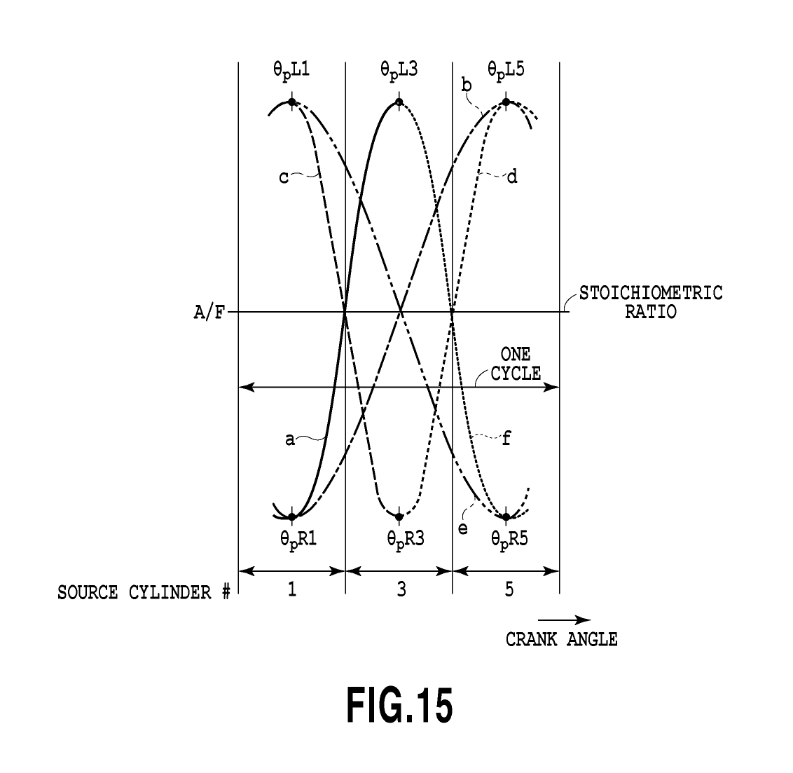

Furthermore, an output waveform from the pre-catalyst sensor 17 is as depicted in FIG. 15. The output waveform is a periodic waveform with a period equal to one engine cycle as is the case with the above-described example. However, the interval between a lean-side peak phase and a rich-side peak phase is not approximately 360° CA but approximately 240° CA or 480° CA. In other words, the output waveform is not symmetric with respect to a certain crank angle. As depicted in FIG. 15, any one of the following six patterns of the output waveform may appear.

(1) A waveform (a) in which a rich-side peak phase θpR1 is present in the phase interval of the #1 source cylinder and in which a lean-side peak phase θpL3 is present in the phase interval of the #3 source cylinder (a pattern of #1 rich and #3 lean).

(2) A waveform (b) in which the rich-side peak phase θpR1 is present in the phase interval of the #1 source cylinder and in which a lean-side peak phase θpL5 is present in the phase interval of the #5 source cylinder (a pattern of #1 rich and #5 lean).

(3) A waveform (c) in which a rich-side peak phase θpR3 is present in the phase interval of the #3 source cylinder and in which a lean-side peak phase θpL1 is present in the phase interval of the #1 source cylinder (a pattern of #3 rich and #1 lean).

(4) A waveform (d) in which the rich-side peak phase θpR3 is present in the phase interval of the #3 source cylinder and in which the lean-side peak phase θpL5 is present in the phase interval of the #5 source cylinder (a pattern of #3 rich and #5 lean).

(5) A waveform (e) in which the rich-side peak phase θpR5 is present in the phase interval of the #5 source cylinder and in which the lean-side peak phase θpL1 is present in the phase interval of the #1 source cylinder (a pattern of #5 rich and #1 lean).

(6) A waveform (f) in which the rich-side peak phase θpR5 is present in the phase interval of the #5 source cylinder and in which the lean-side peak phase θpL3 is present in the phase interval of the #3 source cylinder (a pattern of #5 rich and #3 lean).

In this case, the method in the comparative example enables two estimated abnormal cylinders to be identified. By way of example, it is assumed a the waveform (a) appears and that the #1 cylinder is identified as a rich estimated abnormal cylinder (#1 rich), whereas the #3 cylinder is identified as a lean estimated abnormal cylinder (#3 lean).

Thereafter, the deviation direction determination is performed to determine whether a lean-side deviation or a rich-side deviation is occurring. When the process determines that a lean-side deviation is occurring, the #3 cylinder is identified as the abnormal cylinder. When the process determines that a rich-side deviation is occurring, the #1 cylinder is identified as the abnormal cylinder.

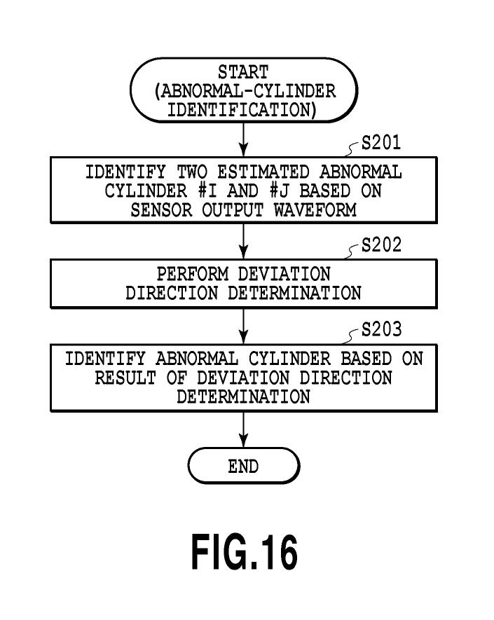

A more specific abnormal-cylinder identification process according to the present embodiment will be described. The identification process is executed by the ECU 20 in accordance with such an algorithm as illustrated in a flowchart in FIG. 16. The identification process is preferably executed only when a prerequisite (step S301 in FIG. 24) for a variation abnormality detection process is established. For easy understanding, the process will be described with appropriate reference to FIG. 4.

First, in step S201, two estimated abnormal cylinders #i and #j (i, j=1, 2, 3, or 4; i≠j) are identified based on such an output waveform from the pre-catalyst sensor 17 during at least one engine cycle as depicted in FIG. 4.

Specifically, the ECU 20 constantly calculates such a relation between the crank angle and the source cylinder as depicted in FIG. 4, that is, determines from which of the cylinders exhaust gas detected by the pre-catalyst sensor 17 at a certain crank angle originates. In this case, the delay time Td may be calculated based on the operating status of the engine (for example, the number of rotations and the load) so that the source cylinder at the certain crank angle can be determined based on the delay time Td. For example, the cylinder set in the exhaust stroke the delay time Td before the current time may be determined to be the source cylinder. Alternatively, four phase intervals during one engine cycle which correspond to the four source cylinders, respectively, may be specified for each engine cycle based on the operating status of the engine. One of such four phase intervals is, for example, such a phase interval between 0° CA and 180° CA corresponding to the #3 source cylinder as depicted in FIG. 4. In this case, the source cylinder can be determined depending on to which of the phase intervals the point in time of a certain crank angle belongs.

Then, the ECU 20 determines the lean-side peak phase θpL and the rich-side peak phase θpR from the sensor output waveform. The ECU 20 identifies the source cylinder corresponding to the lean-side peak phase θpL as a lean estimated abnormal cylinder #i and identifies the source cylinder corresponding to the rich-side peak phase θpL as a rich estimated abnormal cylinder #j.

Then, in step S202, the deviation direction determination is performed in accordance with such a procedure as depicted in the flowchart in FIG. 10. This allows whether a lean-side deviation or a rich-side deviation is occurring to be determined.

Finally, in step S203, based on the result of the deviation direction determination, the abnormal cylinder is identified. That is, upon determining in the deviation direction determination that a lean-side deviation is occurring, the ECU 20 identifies the lean estimated abnormal cylinder #i as the abnormal cylinder. Upon determining in the deviation direction determination that a rich-side deviation is occurring, the ECU 20 identifies the rich estimated abnormal cylinder #j as the abnormal cylinder. This information on the abnormal cylinder (information on the abnormal cylinder number and the deviation direction) is saved to the memory (RAM or the like) in the ECU 20 and utilized for subsequent repairs and the like.

In the above-described example, the estimated abnormal cylinder identification and the deviation direction determination are performed in this order, but this order may be reversed.

The abnormal-cylinder identification process and method according to the present embodiment may be used for or applied to the variation abnormality detection in various applications, stages, and methods. Most generally, the abnormal-cylinder identification process and method are used to identify the abnormal cylinder that causes variation abnormality when the variation abnormality is detected by comparing the output fluctuation parameter X and the determination value α (when the variation abnormality is determined to be present). Other preferred applications are as described below.

### V. Preferred Examples of Variation Abnormality Detection

In general, the output characteristics (gain, responsiveness, and the like) of the air-fuel ratio sensor actually installed in the engine vary between tolerance upper-limit products and tolerance lower-limit products due to manufacturing variations and the like. Hence, the calculated value of the output fluctuation parameter X corresponding to the imbalance rate B varies depending on the pre-catalyst sensor 17.

On the other hand, a desired value for the imbalance rate B which needs to be determined to be abnormal may be legally specified. In such a case, the determination value α is specified in view of the desired value.

However, it has been found that not all the air-fuel ratio sensors 17 can meet the desired value because of the variations among the pre-catalyst sensors 17. That is, it has been found that the tolerance upper-limit products allow abnormality to be detected when the output fluctuation parameter X is smaller than the desired value equivalent, whereas the tolerance lower-limit products may fail to allow abnormality to be detected unless the output fluctuation parameter X exceeds the desired value equivalent. This will be specifically described below.

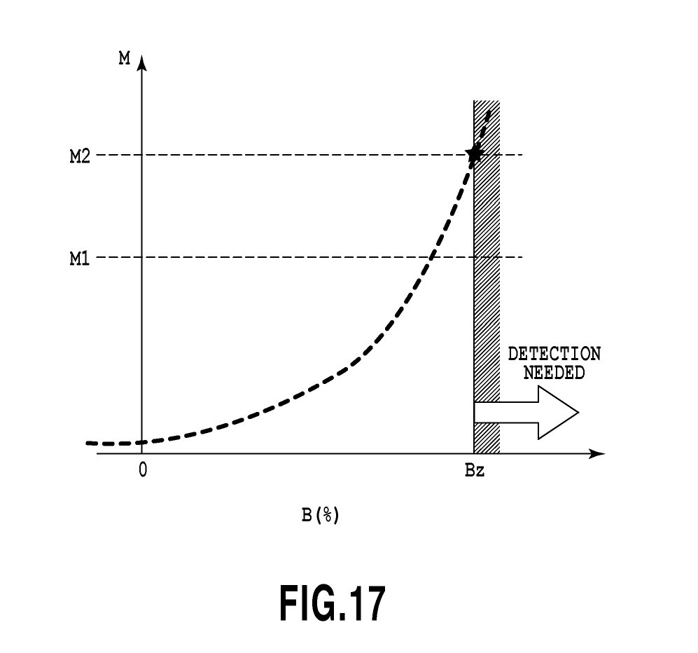

FIG. 17 is a graph illustrating the desired value for the imbalance rate B. The axis of abscissas represents the imbalance rate B(%). The axis of ordinate represents the amount of emission of a particular emission component, in this case, NOx. M1 denotes an emission regulation value legally specified for the amount of NOx emission, and M2 denotes a legally specified OBD regulation value. The OBD regulation value M2 is specified to be, for example, 1.5 times as large as the emission regulation value M1.

As depicted in FIG. 17, the amount of NOx emission M increases as the imbalance rate B(%) increases relative to 0, that is, as the amount of deviation of the air-fuel ratio in one cylinder having a deviation of the air-fuel ratio on the rich side (rich-side imbalance) increases. The imbalance rate Bz(%) corresponding to the OBD regulation value M2 is the desired value. This desired value is hereinafter referred to as a detection-needed imbalance rate.

When the actual imbalance rate B(%) is higher than the detection-needed imbalance rate Bz(%), abnormality inevitably needs to be detected. This is because, if abnormality fails to be detected, the amount of NOx emission M exceeds the OBD regulation value M2. In other words, the detection-needed imbalance rate Bz(%) means a lower limit value for the imbalance rate B that needs to be determined to be abnormal.

The value of the detection-needed imbalance rate Bz (%) varies according to the type of the vehicle or the engine 1. However, the value falls within the range of 40% to 60%.

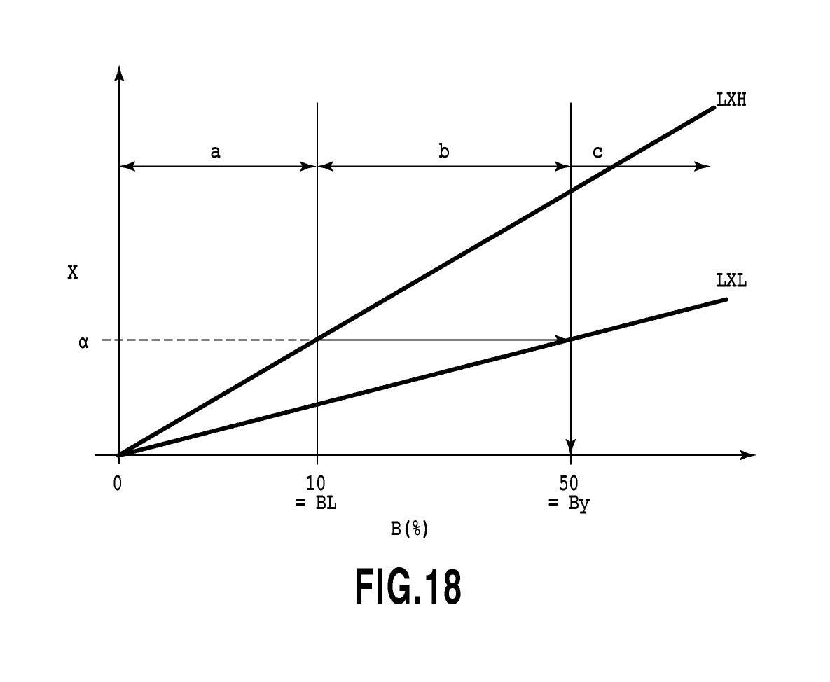

FIG. 18 depicts characteristics or characteristic lines representing the relation between the imbalance rate B(%) and the output fluctuation parameter X obtained when the pre-catalyst sensor 17 is a tolerance upper-limit product and when the pre-catalyst sensor 17 is a tolerance lower-limit product. In FIG. 14, LXH denotes a characteristic or a characteristic line obtained when the pre-catalyst sensor 17 is a tolerance upper-limit product, and LXL denotes a characteristic or a characteristic line obtained when the pre-catalyst sensor 17 is a tolerance lower-limit product. As is known, the tolerance upper-limit product refers to a product with the quickest response within the tolerance range. The tolerance lower-limit product refers to a product with the slowest response within the tolerance range. The present embodiment assumes that the pre-catalyst sensor 17, actually installed in the engine 1, is a normal sensor with responsiveness within the tolerance range.

As depicted in FIG. 18, the imbalance rate B(%) and the output fluctuation parameter X have a linear and first-order proportional relation or characteristic. However, the relation changes in accordance with the output characteristics of the pre-catalyst sensor 17 (hereinafter simply referred to as the sensor output characteristics). For example, the characteristic line LXH of the tolerance upper-limit product has a larger inclination than the characteristic line LXL of the tolerance lower-limit product. The inclination of the characteristic line changes between LXH and LXL depending on the actually installed sensor.

Now, a method for setting or adapting the determination value α in a comparative example will be described. As depicted in FIG. 18, first, the range (a) of the imbalance rate B(%) is determined which is inappropriate to determine to be abnormal (the range to be prevented from being determined to be abnormal) regardless of the sensor output characteristics. In the illustrated example, the range is 10% or less. The range (a) corresponds to the range of variation in imbalance rate B(%) in a reliably normal state. An imbalance rate BL (=10(%)) defining the upper limit value of the range (a) is hereinafter referred to as a lower-limit target imbalance rate. The range (a) corresponds to the range ΔB depicted in FIG. 9 and other figures and within which the deviation direction determination is not performed.

Then, on the characteristic line LXH of the tolerance upper-limit product, the value of the output fluctuation parameter X corresponding to the lower-limit target imbalance rate BL(%) is determined to be the determination value α. The value on the characteristic line LXH of the tolerance upper-limit product is used because the tolerance upper-limit product provides the maximum abnormality-side value of the output fluctuation parameter X.

On the other hand, on the characteristic line LXL of the tolerance lower-limit product, the imbalance rate corresponding to the determination value α is 50(%). In other words, this abnormality detection apparatus fails to accurately detect abnormality unless the actual imbalance rate is higher than 50(%) regardless of the sensor output characteristics. In other words, the abnormality detection apparatus fails to accurately detect abnormality unless the actual imbalance rate B is higher than 50% when the actually installed pre-catalyst sensor 17 is a tolerance lower-limit product. When the pre-catalyst sensor 17 is a tolerance lower-limit product, abnormality can be accurately detected when the level of the imbalance rate is 50(%). Such a range of the imbalance rate that allows abnormality to be accurately detected is denoted by (c). Furthermore, on the characteristic line LXL of the tolerance lower-limit product, an imbalance rate By (=50(%)) corresponding to the determination value α is hereinafter referred to as a lower-limit product detectable imbalance rate.

Within a range (b) between the range (a) and the range (c), abnormality may be detected when the actually installed pre-catalyst sensor 17 is a tolerance upper-limit product.

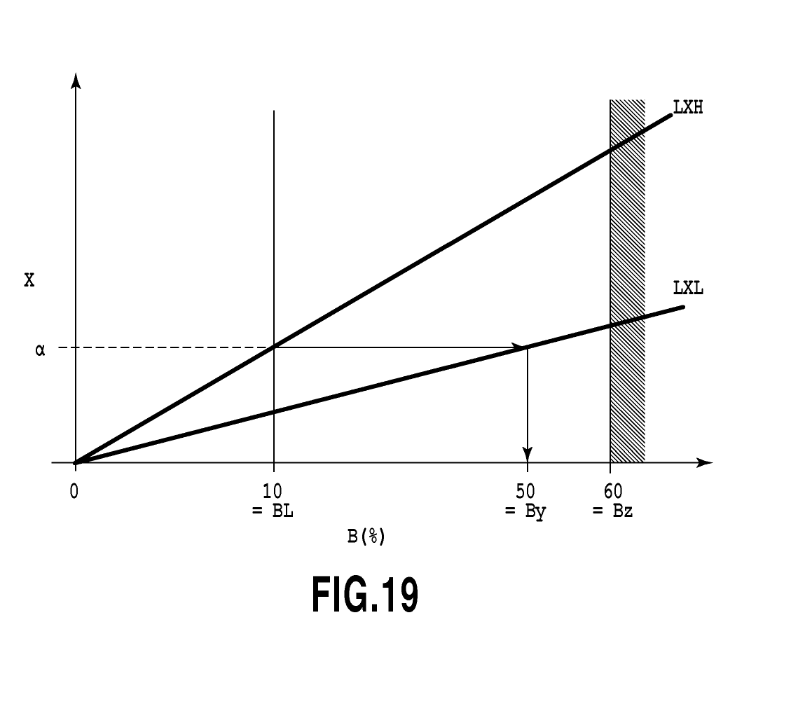

FIG. 19 depicts the comparative example depicted in FIG. 18 in which the detection-needed imbalance rate Bz(%) is 60%. In this case, the detection-needed imbalance rate Bz(%) is higher than the lower-limit detectable imbalance rate By(%), and thus, the abnormality detection apparatus in the comparative example poses no problem. The system consequently functions properly.

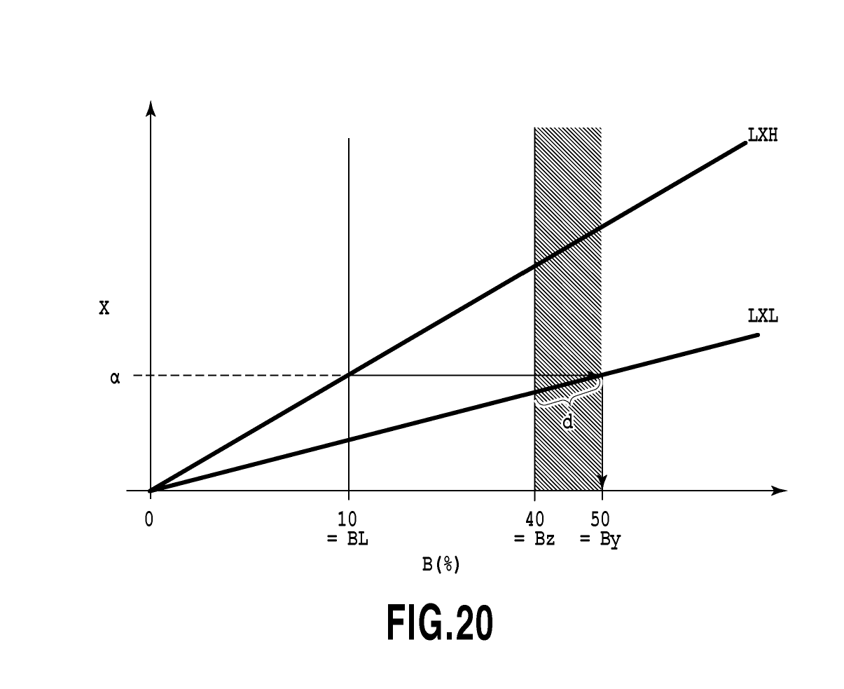

FIG. 20 depicts the comparative example depicted in FIG. 18 in which the detection-needed imbalance rate Bz(%) is 40%. In this case, the detection-needed imbalance rate Bz(%) is lower than the lower-limit product detectable imbalance rate By(%), and thus, the apparatus may fail to accurately detect abnormality when the actually installed pre-catalyst sensor 17 is a tolerance lower-limit product. That is, despite the essential need to detect abnormality within a range (d) from Bz(%) to By(%), the apparatus mistakenly detects normality because the actual value of the output fluctuation parameter X fails to exceed the determination value α. Hence, the abnormality detection apparatus in the comparative example is problematic and the system fails to function properly.

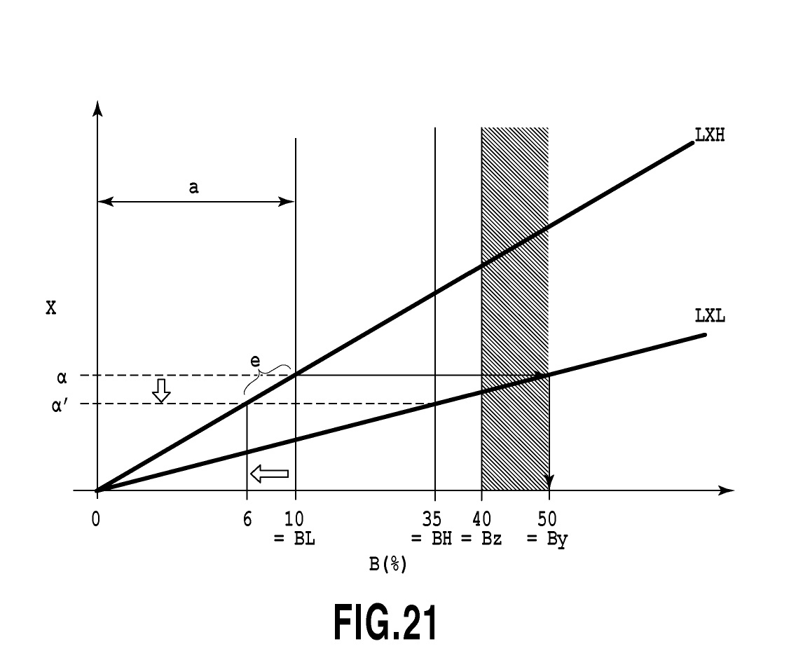

A possible measure against the case in FIG. 20 is as follows. That is, as depicted in FIG. 21, first, an upper-limit target imbalance rate BH(%) is defined which is lower than the detection-needed imbalance rate Bz=40(%) by a predetermined margin. In the illustrated example, this rate is 35(%) and the margin is 5(%).

Then, on the characteristic line LXL of the tolerance upper-limit product, the value of the output fluctuation parameter X corresponding to the upper-limit target imbalance rate BH(%) is determined to be a determination value α′. In other words, the determination value is changed to a smaller value α′ based on the characteristic line LXL of the tolerance lower-limit product. This allows abnormality to be reliably detected before the actual imbalance rate reaches the detection-needed imbalance rate Bz(%) when the actually installed pre-catalyst sensor 17 is a tolerance lower-limit product. Furthermore, such a misdetection as described above can be prevented.

However, in this case, when the actually installed pre-catalyst sensor 17 is a tolerance upper-limit product, abnormality may be detected though the actual imbalance rate is lower than the lower-limit target imbalance rate BL (=10(%)). In the illustrated example, abnormality is detected within a range (e) between 6(%) and 10(%). That is, the lower-limit target imbalance rate BL substantially decreases. Then, abnormality is detected within the range (a) that is essentially inappropriate to determine to be abnormal. This is inconsistent with the above-described assumption.

As described above, when an attempt is made to define a single determination value based on only two characteristic lines, the characteristic line LXH of the tolerance upper-limit product and the characteristic line LXL of the tolerance lower limit product, defining the determination value is difficult if the detection-needed imbalance rate Bz(%) is lower than the lower lower-limit product detectable imbalance rate By(%).

Thus, the present embodiment additionally defines another determination value based on another characteristic line different from the above-described characteristic lines to detect variation abnormality based on these determination values. This enables variation abnormality to be suitably and adequately detected regardless of the sensor output characteristics, particularly even when the actually installed pre-catalyst sensor 17 is a tolerance lower-limit product.

The method for detecting variation abnormality according to the present embodiment will be described below in detail. First, the variation abnormality detection according to the present embodiment is generally performed by the ECU 20 by executing the following steps (A) to (E).

(A) A step of calculating the output fluctuation parameters X.

(B) A step of determining whether or not each of the calculated output fluctuation parameters X is a value between a predetermined primary determination upper-limit value α1H and a predetermined primary determination lower limit value α1L.

(C) A step of performing such forced active control as reduces the deviation of the air-fuel ratio in a cylinder having the most significant deviation of the air-fuel ratio (the above-described abnormal cylinder) when the calculated parameter is determined to be a value between the predetermined primary determination upper-limit value α1H and the predetermined primary determination lower-limit value α1L.

(D) A step of calculating the output fluctuation parameters X while the forced active control is in execution.

(E) A step of comparing each of the output fluctuation parameters X calculated while the forced active control is in execution with a predetermined secondary determination value α2 to determine whether or not variation abnormality is present.

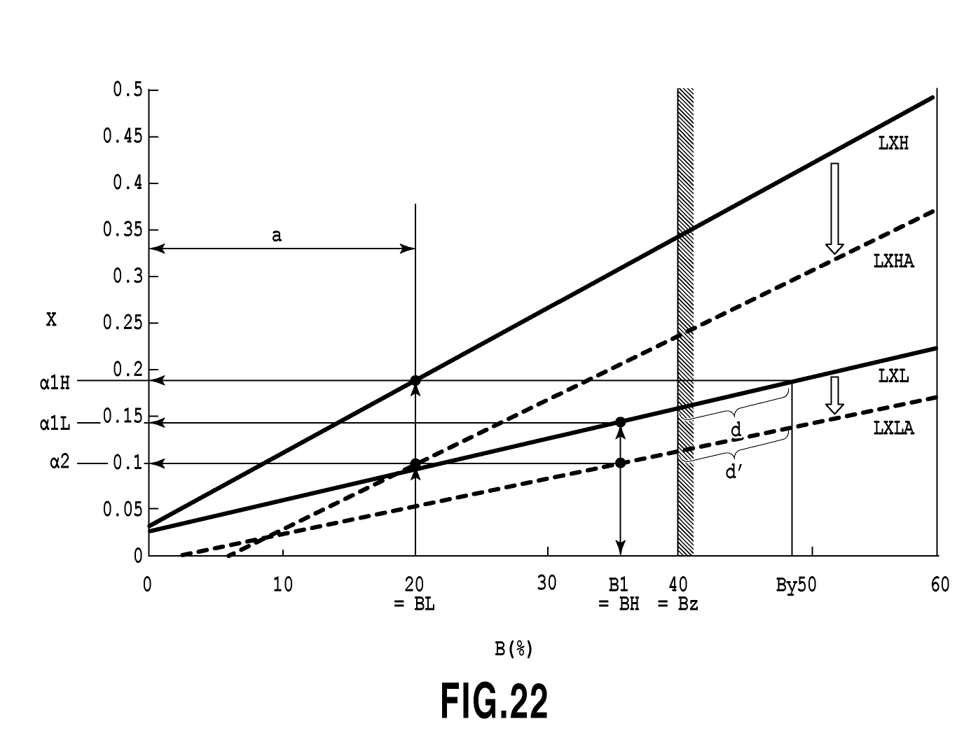

Now, a method for setting the primary determination upper-limit value α1H, the primary determination lower-limit value α1L, and the secondary determination value α2 will be described with reference to FIG. 22. The setting is performed in an adaptation stage, and the set determination values are prestored in the ECU 20.

FIG. 22 depicts characteristics or characteristic lines representing the relation between the imbalance rate B(%) and the output fluctuation parameter X. In particular, the imbalance rate B(%) on the axis of abscissas corresponds to the imbalance rate B(%) obtained in a normal control state, that is, while the stoichiometric control as normal control is in execution, with the forced active control not in execution. When the forced active control is in execution, the forced active control is performed while the stoichiometric control, serving as a base, is in execution.

As described above, LXH denotes a characteristic line obtained when the pre-catalyst sensor 17 is a tolerance upper-limit product, and LXL denotes a characteristic line obtained when the pre-catalyst sensor 17 is a tolerance lower-limit product. Both the characteristic lines are obtained while the forced active control is not in execution.

LXHA denotes a characteristic line obtained when the pre-catalyst sensor 17 is a tolerance upper-limit product and while the forced active control is in execution. Furthermore, LXLA denotes a characteristic line obtained when the pre-catalyst sensor 17 is a tolerance lower-limit product and while the forced active control is in execution. As described below in detail, the characteristic lines in the illustrated example are obtained when the forced active control is performed with a predetermined amount of forced active control Bf.

As seen in FIG. 22, when the forced active control is performed, the characteristic lines LXH and LXL shift toward a decrease side (smaller variation side) of the output fluctuation parameter X. Furthermore, the characteristic difference between the characteristic lines LXH and LXL decreases. This is because the forced active control is such control as reduces the deviation of the air-fuel ratio in one cylinder having the most significant deviation of the air-fuel ratio.

(1) First, as described above, the range (a) of the imbalance rate B(%) is determined which is inappropriate to determine to be abnormal (the range to be prevented from being determined to be abnormal) regardless of the sensor output characteristics. In the illustrated example, the range is 20% or less. That is, the imbalance rate BL defining the upper limit value of the range (a) is 20(%).

(2) Then, on the characteristic line LXH of the tolerance upper-limit product, the value of the output fluctuation parameter X corresponding to the lower-limit target imbalance rate BL(%) is determined to be the primary determination upper-limit value α1H. In the illustrated example, α1H=about 0.19.

(3) Then, on the characteristic line LXHA obtained when the pre-catalyst sensor 17 is a tolerance upper-limit product and while the forced active control is in execution, the output fluctuation parameter X corresponding to the lower-limit target imbalance rate BL(%) is determined to be the secondary determination value α2. In the illustrated example, α2=about 0.1.

(4) Then, on the characteristic line LXLA obtained when the pre-catalyst sensor 17 is a tolerance lower-limit product and while the forced active control is in execution, the value of the imbalance rate B1(%) corresponding to the secondary determination value α2 is determined. Then, whether or not the value B1(%) is equal to or less than the detection-needed imbalance rate Bz(%) is checked. In the illustrated example, B1=about 35(%) and Bz=40(%), and thus, B1(%) is smaller than Bz(%). Hence, the B1(%) is determined to be the upper-limit target imbalance rate BH(%).

(5) Finally, on the characteristic line LXL for a tolerance upper-limit product, the output fluctuation parameter X corresponding to the upper-limit target imbalance rate BH(%) is determined to be the primary determination lower-limit value α1L. In the illustrated example, α1L=about 0.14.

In the illustrated example, the detection-needed imbalance rate Bz (=40%) is lower than the lower-limit product detectable imbalance rate By (=about 48%). Thus, when using only the primary determination upper-limit value α1H, the apparatus mistakenly detects abnormality within the range (d) when the tolerance lower-limit product is actually installed, as described above.

However, the present embodiment first determines whether or not the actually calculated output fluctuation parameter X has a value between the primary determination upper-limit value α1H and the primary determination lower-limit value α1L, that is, whether or not the parameter is in a gray zone in which the apparatus may mistakenly detect normality when the tolerance lower-limit product is actually installed. If the result of the determination is affirmative, the forced active control is performed, and the output fluctuation parameter X calculated while the forced active control is in execution is compared with the secondary determination value α2 to allow determination of whether or not variation abnormality is present. In other words, if the actually calculated output fluctuation parameter X is in the gray zone, the forced active control is performed to change the characteristic line to the characteristic line LXHA or LXLA, which has a smaller characteristic difference. Then, with the upper-limit target imbalance rate BH set lower than the detection-needed imbalance rate Bz (%), whether or not variation abnormality is present is determined.

As a result, the execution of the forced active control shifts the value in the range (d) to a value in a range d′. The value in the range d′ is larger than the secondary determination value α2, allowing the determination of the presence of abnormality. This avoids misdetection to allow variation abnormality to be suitably and adequately detected even when the actually installed pre-catalyst sensor 17 is a tolerance lower-limit product.

Furthermore, the present embodiment allows the suitable and adequate detection, in the normal control state, of variation abnormality within the range of BH to Bz, which is lower than the range of Bz to By. This enables sufficient satisfaction of the legal requirement that abnormality be inevitably detected when the actual imbalance rate B(%) exceeds the detection-needed imbalance rate Bz(%).

The reason why whether or not the B1(%) is equal to or lower than the detection-needed imbalance rate Bz(%) is as follows. The characteristic lines LXHA and LXLA, obtained while the forced active control is in execution, change depending on what amount of forced active control is performed, in other words, to what value the forced active control is set. Hence, in some cases, the B1(%) is higher than the detection-needed imbalance rate Bz(%). However, this precludes the system from functioning properly. Thus, the B1(%) is determined to be the upper-limit target imbalance rate BH(%) only when the B1(%) is equal to or lower than the detection-needed imbalance rate Bz(%). If, in contrast, the B1(%) is higher than the detection-needed imbalance rate Bz(%), an adaptation operation such as a change in the amount of forced active control is performed again.

In this case, the upper-limit target imbalance rate BH(%) is set to have a smaller value than the detection-needed imbalance rate Bz(%). However, the upper-limit target imbalance rate BH(%) may be set to have a value equal to the value of the detection-needed imbalance rate Bz(%).

The output fluctuation parameter X may be referred to as the “first parameter”. The imbalance rate B(%) may be referred to as the “second parameter”. The characteristic line LXLA may be referred to as the “first characteristic line”. The upper-limit target imbalance rate BH(%) may be referred to as the “upper-limit target value of the second parameter”. The characteristic line LXL may be referred to as the “second characteristic line”. The characteristic line LXH may be referred to as the “third characteristic line”. The lower-limit target imbalance rate BL(%) may be referred to as the “lower-limit target value of the second parameter”.

Now, the forced active control performed in the above-described step (C) will be described. The forced active control is such control as reduces the deviation of the air-fuel ratio in one cylinder (abnormal cylinder) having the most significant deviation of the air-fuel ratio, that is, what is called reverse active control.

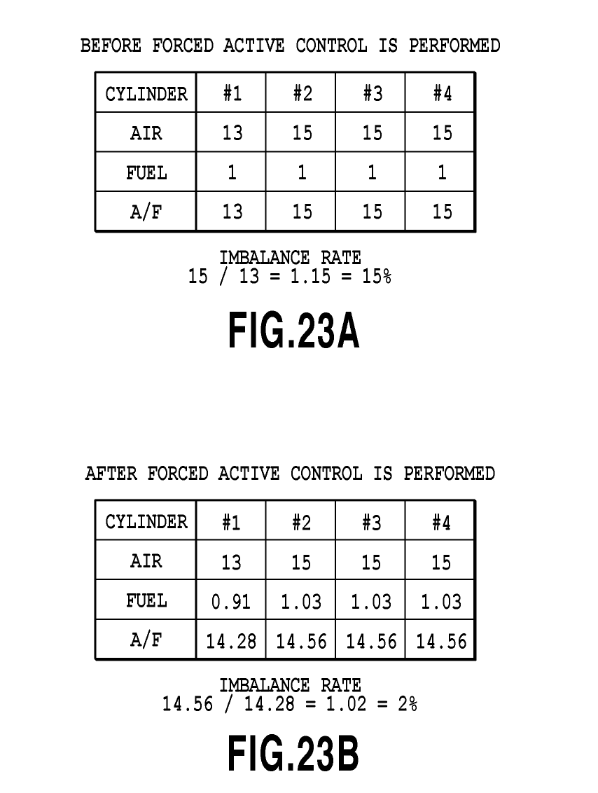

FIGS. 23A and 23B are tables for comparison of the imbalance rates obtained before the forced active control is performed (before execution) and after the forced active control is performed (after execution). Here, all the values of the amount of fuel and the air-fuel ratio depicted in FIGS. 23A and 23B are obtained after the air-fuel ratio of the total gas converges to the stoichiometric value (14.5) as a result of the stoichiometric control.

FIG. 23A depicts a state where imbalance is present in the normal control state and where the forced control active control has not been performed yet. As is apparent from FIG. 23(A), the amount of fuel is 1 in all the cylinders, but the amount of air varies due to the abnormality of a pneumatic system for the #1 cylinder; the amount of air is 13 only in the #1 cylinder and 15 in the other cylinders. Hence, the imbalance rate is 15/13=1.15=15%. The #1 cylinder has a rich-side deviation of the air-fuel ratio.

This state may occur when, for example, a cylinder intake passage (branch pipe 4 or intake port) in the #1 cylinder is blocked by deposits or the like or the intake valve is inappropriately opened.

FIG. 23B depicts a state resulting from execution of the forced control active control in the state in FIG. 23A. In this case, for a reduction in the rich-side deviation in the #1 cylinder, the amount of fuel only in the #1 cylinder is forcibly decreased. As a result of such reduction and the stoichiometric control, the amount of fuel is 0.91 only in the #1 cylinder and 1.03 in the other cylinders. The air-fuel ratio is 14.28 only in the #1 cylinder and 14.56 in the other cylinders. Hence, the imbalance rate is 14.56/14.28=1.02=2%.

For the amount of fuel, the imbalance rate for the amount of fuel is 1.03/0.91=1.13=13%. In contrast, in the state where the forced control active control has not been performed yet as depicted in FIG. 23A, the imbalance rate of the amount of fuel is 1/1=1=0%. This means that the execution of the forced control active control has forcibly reduced the amount of fuel in the #1 cylinder having a rich-side deviation, by 13% in terms of the imbalance rate for the amount of fuel.

Thus, the imbalance rate for the amount of fuel=13% is considered to be the amount of reduction in the deviation of the air-fuel ratio achieved by the forced control active control according to the present embodiment, that is, the amount of forced active control Bf. In other words, if any one cylinder has a rich-side deviation, the amount of fuel is forcibly reduced only in the cylinder by a value equivalent to the imbalance rate for the amount of fuel, 13%. The value of 13% is illustrative and can be appropriately changed.

The amount of forced control active control Bf as described above is prestored in the ECU 20 as a constant value. Furthermore, the characteristic lines LXHA and LXLA, depicted in FIG. 18 and obtained while the forced control active control is in execution, result from the execution of the forced control active control with the same amount of forced control active control Bf.

The execution of the forced control active control needs identification of one of all the cylinders that has the most significant deviation of the air-fuel ratio, that is, an abnormal cylinder. Thus, the abnormal-cylinder identification process and method according to the present embodiment as described above are suitably used.

Now, a variation abnormality detection process according to the present embodiment will be described. The detection process is executed by the ECU 20 in accordance with such an algorithm as illustrated in a flowchart in FIG. 24.

First, in step S301, the ECU 20 determines whether a predetermined prerequisite suitable for execution of variation abnormality detection is established. For example, the prerequisite is established when the following conditions are established.

(1) Warm-up of the engine is complete.

(2) The pre-catalyst sensor 17 and the post-catalyst sensor 18 have been activated.

(3) The upstream catalyst 11 and the downstream catalyst 19 have been activated.

(4) The number of rotations Ne of the engine and a load KL on the engine fall within the respective predetermined ranges. For example, the number of rotations Ne is between 1,200 (rpm) and 2,000 (rpm), and the load KL is between 40(%) and 60(%).

(5) The stoichiometric control is in execution.

Another example of the prerequisite may be specified. For example, the condition that (6) the engine is operating steadily may be added.

If the prerequisite is not established, the ECU 20 waits. When the prerequisite is established, the ECU 20 proceeds to step S302. In this case, steps subsequent to step S302 are assumed to be executed only when the prerequisite is established.

In step S302, the output fluctuation parameter X₁ is calculated which is obtained in the normal control state where the forced active control is not in execution.

In step S303, the ECU 20 determines whether or not the calculated value of the output fluctuation parameter X₁ is between the primary determination upper-limit value α1H and the primary determination lower limit-value α1L, that is, within the range of α1L<X₁≦α1H. Such determination or judgment is referred to as primary determination.

When the calculated value is within the range of α1L<X₁≦α1H, any one of the cylinders is expected to have such a relatively slight deviation of the air-fuel ratio as belongs to the above-described gray zone. Thus, in this case, in step S304, the abnormal cylinder is identified which is the target cylinder for the forced active control. At this time, the abnormal-cylinder identification process and method according to the present embodiment as described above is suitably used. The identification of the abnormal cylinder is performed in accordance with such an identification process as depicted in FIG. 16.

Then, in step S305, the forced active control is performed. That is, the amount of fuel injected in the abnormal cylinder is reduced or increased by a predetermined value so as to reduce the deviation of the air-fuel ratio in the abnormal cylinder.

In step S306, the value of the output fluctuation parameter X₂ obtained while the forced active control is in execution is calculated.

In step S307, the calculated value of the output fluctuation parameter X₂ is compared with the secondary determination value α2 to allow determination of whether the output fluctuation parameter X₂ is larger or smaller than the secondary determination value α2. Such determination or judgment is referred to as secondary determination.

If the value of the output fluctuation parameter X₂ is equal to or smaller than the secondary determination value α2, the ECU 20 determines in step S308 that variation abnormality is absent, that is, the cylinder is normal. The abnormal cylinder identified in step S304 is finally determined not to be abnormal.

On the other hand, if the value of the output fluctuation parameter X₂ is larger than the secondary determination value α2, the ECU 20 determines in step S309 that variation abnormality is present, that is, the cylinder is abnormal. The abnormal cylinder identified in step S304 is finally determined to be abnormal. In this case, an alarm apparatus such as a check lamp is activated to inform the user of the abnormality, thus urging the user to make a relevant repair. Furthermore, information on the abnormal cylinder is stored in the ECU 20.

In step S303, if the value of the output fluctuation parameter X₁ in the normal control state falls out of the range of α1L<X₁≦α1H, the cylinder is expected to be definitely normal or abnormal. Thus, in this case, the value of the output fluctuation parameter X₁ is compared, in step S310, with the primary determination lower-limit value α1L to allow direct determination of whether the engine is in a normal state or an abnormal state.

That is, if the value of the output fluctuation parameter X₁ is equal to or smaller than the primary determination lower-limit value α1L, the ECU 20 determines in step S311 that variation abnormality is absent, that is, the engine is in the normal state.

On the other hand, if the value of the output fluctuation parameter X₁ is larger than the primary determination lower-limit value α1L, this means that the value of the output fluctuation parameter X₁ is larger than the primary determination upper-limit value α1H. In step S312, the ECU 20 thus determines that variation abnormality is present, that is, the engine is in the abnormal state. In this case, any one of the cylinders is expected to have a relatively significant deviation of the air-fuel ratio.

Possible methods for directly determining whether the cylinder is normal or abnormal include not only comparison only with the primary determination lower-limit value α1L as described above but also comparison only with the primary determination upper-limit value α1H and comparison both with the primary determination lower-limit value α1L and with the primary determination upper-limit value α1H.

As described above, the ECU 20 also executes the following step (F).

F) A step of comparing the output fluctuation parameter X₁ with at least one of the primary determination upper- and lower-limit values α1H and α1L to determine whether or not the variation abnormality is present when the ECU 20 determines in step (B) that the output fluctuation parameter X₁ is not a value between the primary determination upper-limit value α1H and the primary determination lower-limit value α1L.

The preferred embodiment of the present invention has been described in detail. However, various other embodiments are possible for the present invention. For example, the above-described numerical values are illustrative and may be variously changed. Furthermore, if only one of the rich and lean sides is described in any portion of the above description, it should be easily understood by those skilled in the art that the description of that side is applicable to the other side.

When two estimated abnormal cylinders are identified from the sensor output waveform, the identification need not necessarily be based on the two peak phases θpL and θpR. Various other identification methods are possible. When similar processing is executed on the lean side and on the rich side, the order of processing is optional.

The embodiment of the present invention is not limited to the above-described embodiment. The present invention includes any variations, applications, and equivalents embraced by the concepts of the present invention defined by the claims. Thus, the present invention should not be interpreted in a limited manner but is applicable to any other techniques belonging to the scope of the concepts of the present invention.

What is claimed is:

1. An inter-cylinder air-fuel ratio variation abnormality detection apparatus comprising:
an air-fuel ratio sensor installed in an exhaust passage common to a plurality of cylinders in a multicylinder internal combustion engine; and
a control apparatus configured to calculate an output fluctuation parameter correlated with a degree of variation in output from the air-fuel ratio sensor and to detect an inter-cylinder air-fuel ratio variation abnormality based on the calculated output fluctuation parameter,
wherein the control apparatus is configured to execute:
(a) a step of calculating, for an output waveform from the air-fuel ratio sensor during at least one cycle of the internal combustion engine, a positive slope value indicative of a magnitude of a slope of the output from the air-fuel ratio sensor obtained when the output from the air-fuel ratio sensor changes to a lean side and a negative slope value indicative of the magnitude of the slope obtained when the output from the air-fuel ratio sensor changes to a rich side;
(b) a step of calculating a determination index value by dividing a difference or a ratio between the positive slope value and the negative slope value by an amplitude index value correlated with a magnitude of a maximum amplitude of the output waveform from the air-fuel ratio sensor; and
(c) a step of determining whether a deviation of the air-fuel ratio in one cylinder with a most significant deviation of the air-fuel ratio is a lean-side deviation or a rich-side deviation, based on the determination index value.

2. The inter-cylinder air-fuel ratio variation abnormality detection apparatus according to claim 1, wherein the amplitude index value is a sum of the positive slope value and the negative slope value.

3. The inter-cylinder air-fuel ratio variation abnormality detection apparatus according to claim 1, wherein, in the step (c), the control apparatus compares the determination index value with a predetermined threshold to determine whether the deviation of the air-fuel ratio is a lean-side deviation or a rich-side deviation.

4. The inter-cylinder air-fuel ratio variation abnormality detection apparatus according to claim 3, wherein, in the step (b), the control apparatus calculates the determination index value by subtracting the negative slope value from the positive slope value and dividing a resultant difference by the amplitude index value, and
the threshold is a negative value.

5. The inter-cylinder air-fuel ratio variation abnormality detection apparatus according to claim 3, wherein, in the step (C), the control apparatus corrects the determination index value or the threshold depending on an operating status of the internal combustion engine.

6. The inter-cylinder air-fuel ratio variation abnormality detection apparatus according to claim 1, wherein the control apparatus is configured to execute, before the step (a),
(d) a step of identifying a total of two cylinders including one cylinder estimated to have a lean-side deviation of the air-fuel ratio and one cylinder estimated to have a rich-side deviation of the air-fuel ratio based on the output waveform from the air-fuel ratio sensor during at least one cycle of the internal combustion engine, and after the step (c),
(e) a step of identifying one of the two cylinders identified in the step (d) that has the most significant deviation of the air-fuel ratio.

7. The inter-cylinder air-fuel ratio variation abnormality detection apparatus according to claim 6, wherein, in the step (d), the control apparatus identifies the two cylinders based on a lean-side peak phase and a rich-side peak phase of the output waveform from the air-fuel ratio sensor.

8. The inter-cylinder air-fuel ratio variation abnormality detection apparatus according to claim 6, wherein the control apparatus is configured to execute, when performing variation abnormality detection,
(f) a step of calculating the output fluctuation parameter;
(g) a step of determining whether or not the calculated output fluctuation parameter is a value between a predetermined primary determination upper-limit value and a predetermined primary determination lower-limit value;
(h) a step of performing, on one cylinder with the most significant deviation of the air-fuel ratio, such forced active control as reduces the deviation of the air-fuel ratio when the calculated output fluctuation parameter is a value between the primary determination upper-limit value and the primary determination lower-limit value;
(i) a step of calculating the output fluctuation parameter while the forced active control is in execution; and
(j) a step of comparing the output fluctuation parameter calculated while the forced active control is in execution with a predetermined secondary determination value to determine whether or not a variation abnormality is present,
wherein the control apparatus executes the steps (a) to (e) when identifying the one cylinder with the most significant deviation of the air-fuel ratio in the step (h).

9. The inter-cylinder air-fuel ratio variation abnormality detection apparatus according to claim 1, wherein the output waveform from the air-fuel ratio sensor is a periodic waveform with a period equal to one cycle of the internal combustion engine.
